(19) United States
(12) Patent Application Publication
(10) Pub. No.: US 2020/0012281 A1
(43) Pub. Date: Jan. 9, 2020

(54) VEHICLE OF AUTOMATIC DRIVING SYSTEM AND THE CONTROL METHOD OF THE SYSTEM

(71) Applicant: LG Electronics Inc., Seoul (KR)

(72) Inventor: Chan JAEGAL, Seoul (KR)

(21) Appl. No.: 16/555,797

(22) Filed: Aug. 29, 2019

(30) Foreign Application Priority Data
Jul. 25, 2019 (KR) 10-2019-0090120

(51) Int. Cl. G05D 1/00; B60W 40/08

(52) U.S. Cl. CPC G05D 1/0088; G05D 1/0061; B60W 40/08; B60W 30/18163; B60W 2510/06; B60W 2510/10; B60W 2040/0872

(57) ABSTRACT

A method of controlling a vehicle operating in an Automated Vehicle and Highway System (AVHS) includes: transmitting a driving assistance request to a server in response to satisfaction of a preset condition or in response to a user input; in response to the driving assistance request, receiving a connection request from a drone selected by the server; initiating data transmission and reception for autonomous driving by authenticating the connection request; and performing the autonomous driving using driving assistance data received from the drone. Implementations of the present disclosure may enable improved autonomous driving support for a vehicle having a problem in performing autonomous driving or a manually driven vehicle incapable of driving autonomously. One or more of an autonomous vehicle or a server may be linked to an Artificial Intelligence (AI) module, Unmanned Aerial Vehicle (UAV) robot, Augmented Reality (AR) device, Virtual Reality (VR) device, a 5G service-related device, etc.

### CROSS-REFERENCE TO RELATED APPLICATIONS

This application claims the benefit of Korea Patent Application No. 10-2019-0090120, filed on Jul. 25, 2019, which is incorporated herein by reference for all purposes as if fully set forth herein.

### BACKGROUND OF THE INVENTION

### Field of the Invention

The present invention relates to an automatic driving system, and more particularly to an automatic driving system enabled to assisting autonomous driving of a vehicle.

### Related Art

A Vehicle may be classified as an internal combustion engine vehicle, an external combustion engine vehicle, a gas turbine vehicle, an electric vehicle, or the like according to a type of an engine.

Recently, a smart vehicle is being actively developed for safety or convenience of a driver, a pedestrian, and the like, and researches on a sensor embedded in the smart vehicle are being actively conducted. A camera, an infrared sensor, a Radar, a Global Positioning System (GPS), a Lidar, a gyroscope, and the like are used in the smart vehicle. Among them, the camera plays a role to substitute human eyes.

Due to development of various sensors and electronic devices, a vehicle having driving assistant auxiliary functions to assist a driver and improve safety and convenience are drawing attention.

Meanwhile, a user has to drive by himself/herself a vehicle that cannot normally perform autonomous driving, for example, a vehicle in which an error has occurred in an autonomous driving-related sensor and or a manually driven vehicle which does not support an autonomous driving function. However, there are some cases in which a user cannot drive by himself/herself due to a health issue (old age, being drunken, pregnancy, injury) or any other reason. In such cases, it is necessary to assist driving of the autonomous vehicle or to support autonomous driving of a manually driven vehicle.

### SUMMARY OF THE INVENTION

The present invention aims to solve the aforementioned problem.

In addition, the present invention aims to provide an Automated Vehicle and Highway System (AVHS) and a vehicle included in the same, the AVHS which quickly supports driving assistance when the vehicle has a problem in performing autonomous driving, thereby enabling the vehicle to perform the autonomous driving.

In addition, the present invention aims to provide an AVHS and a vehicle included in the same, the AVHS which enables a driving assistance request to be performed in consideration of various situations.

In addition, the present invention aims to provide an AVHS and a vehicle included in the same, the AVHS which is capable of enhancing security when it comes to supporting driving assistance.

In addition, the present invention aims to provide an AVHS and a vehicle included in the same, the AVHS which is capable of transmitting in real time a situation before driving assistance for the vehicle is initiated.

In addition, the present invention aims to provide an AVHS and a vehicle included in the same, the AVHS which is capable of enhancing safety when it comes to supporting driving assistance.

In one general aspect of the present invention, there is provided a method of controlling a vehicle operating in an Automated Vehicle and Highway System (AVHS), the method including: transmitting a driving assistance request to a server in satisfying of a preset condition or according to an input of a user; receiving a connection request from a drone selected by the server according to the driving assistance request; initiating data transmission and reception for autonomous driving by authenticating the connection request; and performing the autonomous driving using driving assistance data received from the drone, wherein the driving assistance data comprises at least one of first sensor data acquired through a sensor of the drone, second sensor data acquired through a sensor of a drone, the sensor corresponding to a sensor in which an error is detected among sensors of the vehicle, or an autonomous driving control signal indicating an operation of the vehicle.

In the transmitting of the driving assistance request, the vehicle may transmit the driving assistance request when an error is detected in at least one sensor, when an accident possibility is equal to or higher than a predetermined level, or when occurrence of an emergency is sensed.

The driving assistance request may include at least one of a driving destination, a state of the user, information related to the autonomous driving of the vehicle, a location of the vehicle, or identification information of the vehicle.

The state of the user may include at least one of whether the user is drunk, whether the user is elderly, whether the user is pregnant, or any other information related to health of the user, the information related to the autonomous driving of the vehicle may include at least one of whether the vehicle is allowed to travel, whether an accident of the vehicle happens, information on a sensor in which the error is detected among sensors of the vehicle, and whether the vehicle supports an autonomous driving function, and the identification information of the vehicle may include at least one of a color, a type, or a licensed number of the vehicle.

The transmitting of the driving assistance request further may include: receiving information on the drone selected by the server; and receiving an authentication key that is generated by the server to connect the drone and the vehicle.

The authentication key may be valid only before a preset valid time expires since a generation timing of the authentication key.

When a valid time of the authentication key expires, the vehicle may request update of the authentication key from the server and receives a re-generated authentication key from the server

The receiving of the connection request may include: receiving real-time information related to a location of the drone from the server; and, when a distance between the drone and the vehicle is equal to or smaller than a predetermined value, receiving the connection request from the drone.

The real-time information may include at least one of a current location of the drone, a moving path of the drone, or a time required for the drone to arrive at the vehicle.

The initiating of the data transmission and reception may include: verifying validity of the connection request and transmitting connection approval to the drone; and, initiating the data transmission and reception with the drone, when the drone moves to a preset location in response to reception of the connection approval and is then electrically connected to the vehicle.

The preset location may be a landing point provided in an exterior of the vehicle or a location in a region formed at a preset distance from the vehicle.

When the data transmission and the reception is initiated, the vehicle may transmit, to the drone, at least one of fuel of the vehicle, a remaining battery capacity of the vehicle, or real-time information of the vehicle related to the autonomous driving.

In the performing of the autonomous driving using the driving assistance data, when the vehicle does not support an autonomous driving function, the vehicle may perform the autonomous driving using at least one of sensor data acquired through a normally operating sensor or sensor data received from the drone, or, when the vehicle does not support the autonomous driving function, the vehicle may operate in accordance with the autonomous driving control signal.

The autonomous driving control signal may indicate an operation of vehicular elements related to at least one of turning on/off ignition, a driving speed, gear shift, an engine RPM, turning on/off a head light, turning on/off a turn signal, or lane change.

In another general aspect of the present invention, there is provided A control method of an Automated Vehicle and Highway System (AVHS), the method including: transmitting, by a vehicle, a driving assistance request to a server in response to satisfaction of a preset condition or in response to an input of a user; transmitting, by the server, location information of the vehicle to a drone having a sensor for assisting autonomous driving of the vehicle; approaching the vehicle and transmitting a connection request by the drone; initiating, by the vehicle, data transmission and reception for autonomous driving by authenticating the connection request; and performing, by the vehicle, the autonomous driving using driving assistance data received from the drone, wherein the driving assistance data comprises at least one of first sensor data acquired through a sensor of the drone, second sensor data acquired through a sensor of a drone, which corresponds to a sensor in which an error is detected among sensors of the vehicle, or an autonomous driving control signal indicating an operation of the vehicle.

In yet another aspect of the present invention, there is provided a vehicle operating in an Automated Vehicle and Highway System (AVHS) including a server and at least one drone which operate in conjunction for autonomous driving of the vehicle, the vehicle including: an interface unit configured to receive an input of a user, monitor a state of the user, and provide information generated by the vehicle to the user; a sensor unit having a plurality of sensors for detecting an object located outside the vehicle; a communication unit configured to transmit and receive an autonomous driving-related signal to an outside of the vehicle; and a controller configured to control driving related to the autonomous driving of the vehicle in conjunction with the server and the drone.

The controller may be configured to transmit a driving assistance request to the server in response to satisfaction of a preset condition or in response to an input of a user; receive a connection request from a drone selected by the server in response to the driving assistance request, initiate data transmission and reception for autonomous driving by authenticating the connection request, and perform the autonomous driving using driving assistance data received from the drone, wherein the driving assistance data comprises at least one of first sensor data acquired through a sensor of the drone, second sensor data acquired through a sensor in a drone, which corresponds to a sensor in which an error is detected among sensors of the vehicle, or an autonomous driving control signal indicating an operation of the vehicle.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

FIG. 1 shows an exemplary block diagram of a wireless communication system to which methods proposed in the present specification is applicable.

FIG. 2 shows an example of a method of transmitting and receiving signals in a wireless communication system.

FIG. 3 shows an example of basic operations between an autonomous vehicle and a 5G network in a 5G communication system.

FIG. 4 shows an example of basic operations between one vehicle and another vehicle using 5G communications.

FIG. 5 is a diagram showing a vehicle according to an embodiment of the present invention.

FIG. 6 is a control block diagram of a vehicle according to an embodiment of the present invention.

FIG. 7 is a control block diagram of an autonomous driving device 100 according to an embodiment of the present invention.

FIG. 8 is a signal flowchart of an autonomous vehicle according to an embodiment of the present invention.

FIG. 9 is a diagram showing an interior of a vehicle according to an embodiment of the present invention.

FIG. 10 is a block diagram for explaining a vehicular cabin system according to an embodiment of the present invention.

FIG. 11 is a diagram referred to for explaining a use scenario for a user according to an embodiment of the present invention.

FIG. 12 is a diagram for explaining a configuration of an Automated Vehicle and Highway System (AVHS) according to an embodiment of the present invention.

FIG. 13 is a flowchart for explaining a control method of an AVHS according to an embodiment of the present invention.

FIG. 14 is a flowchart for explaining in detail a step to transmit location information of a vehicle in a control method of an AVHS according to an embodiment of the present invention.

FIG. 15 is a flowchart for explaining in a detail a step to request connection in a control method of an AVHS according to an embodiment of the present invention.

FIG. 16 is a flowchart for explaining in a detail a step to initiate data transmission and reception for autonomous driving in a control method of an AVHS according to an embodiment of the present invention.

FIG. 17 is a flowchart for explaining in detail a step to perform autonomus driving using driving assistance data in a control method of an AVHS according to an embodiment of the present invention.

FIG. 18 is a flowchart for explaining a method for controlling a vehicle operating in an AVHS according to an embodiment of the present invention.

FIG. 19 is a flowchart for explaining in more detail a step to request driving assistance in a method for controlling a vehicle operating in an AVHS according to an embodiment of the present invention.

FIG. 20 is a flowchart for explaining in detail a step to receive a connection request in a method for controlling a vehicle operating in an AVHS according to an embodiment of the present invention.

FIG. 21 is a flowchart for explaining in detail a step to initiate data transmission and reception for autonomous driving in a method for controlling a vehicle operating in an AVHS according to an embodiment of the present invention.

FIG. 22 is a diagram for explaining in detail a data flow between elements in an AVHS according to an embodiment of the present invention

FIG. 23 is a diagram for explaining an example to which the present invention is applied when it comes to a driving assistance request. It is assumed that an error occurs in some of sensors in the vehicle 10 and that the vehicle 10 supports an automatically driving function.

FIG. 24 is a diagram for explaining another example to which the present invention is applied when it comes to a driving assistance request

The accompanying drawings, which are included to provide a further understanding of the invention and are incorporated in and constitute a part of this application, illustrate embodiments of the invention and together with the description serve to explain the principle of the invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of Block Diagram of UE and 5G Network

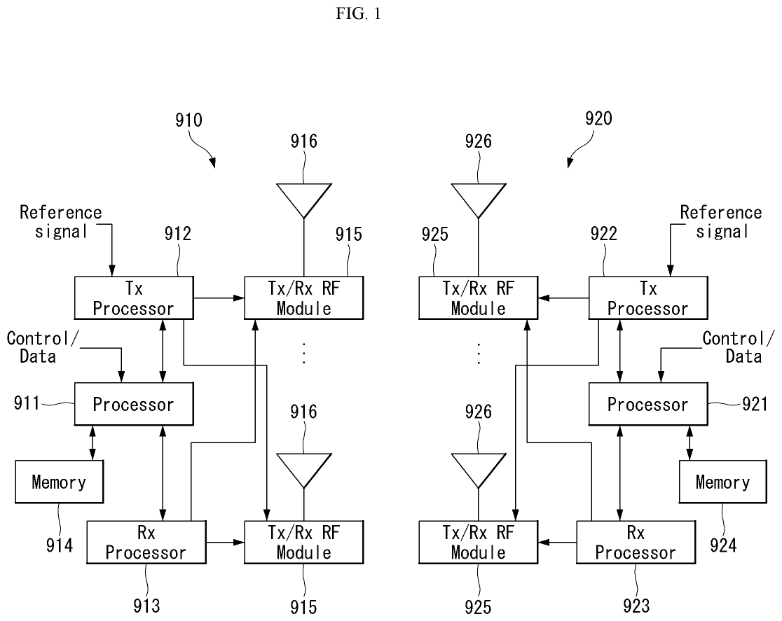

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

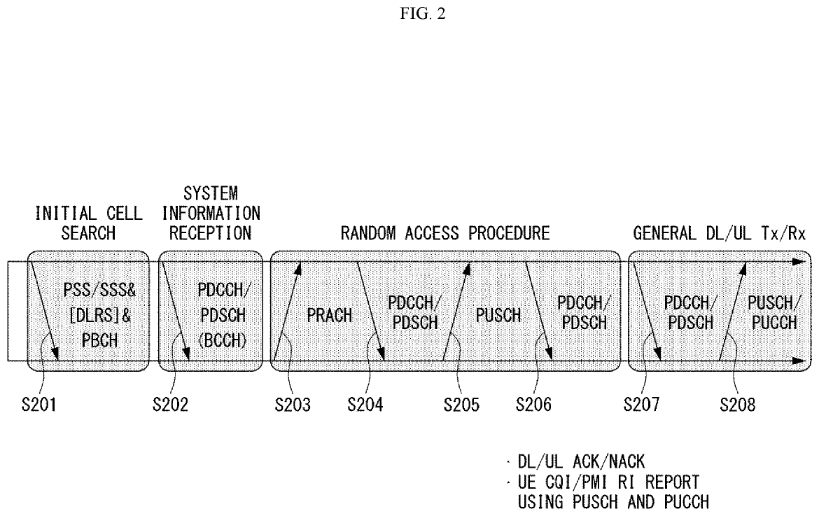

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles Using 5G Communication

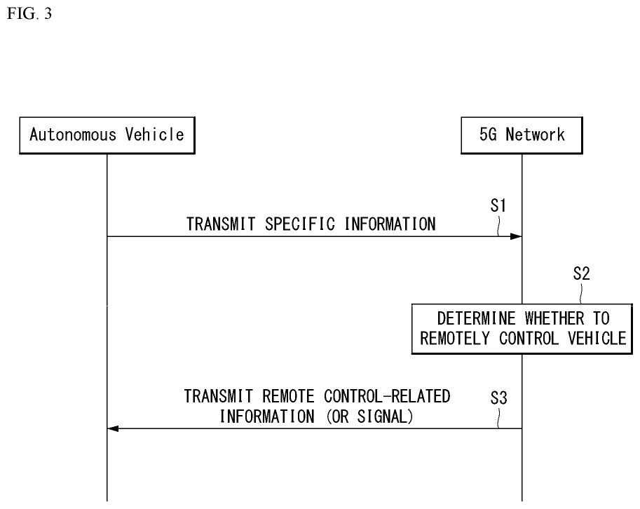

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation Between Vehicles Using 5G Communication

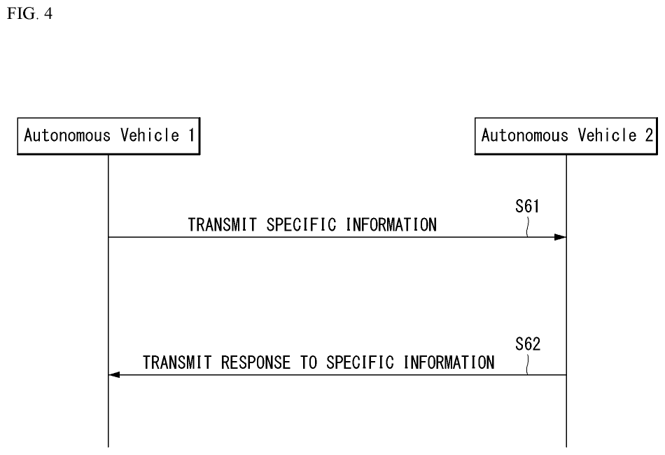

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

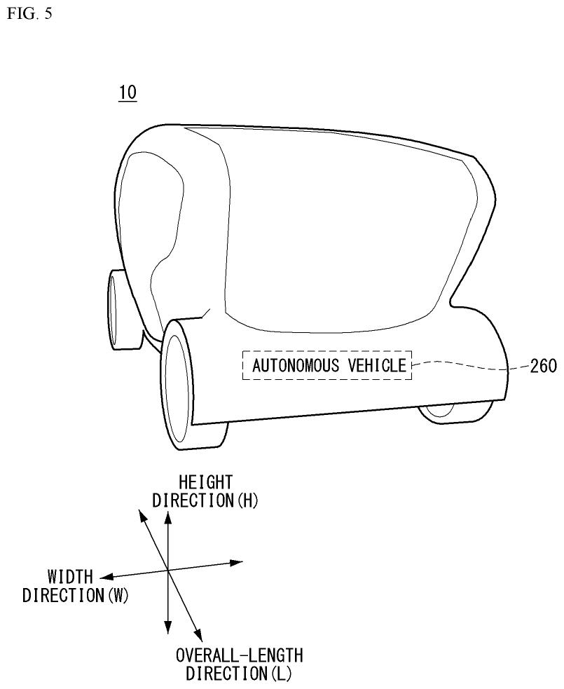

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

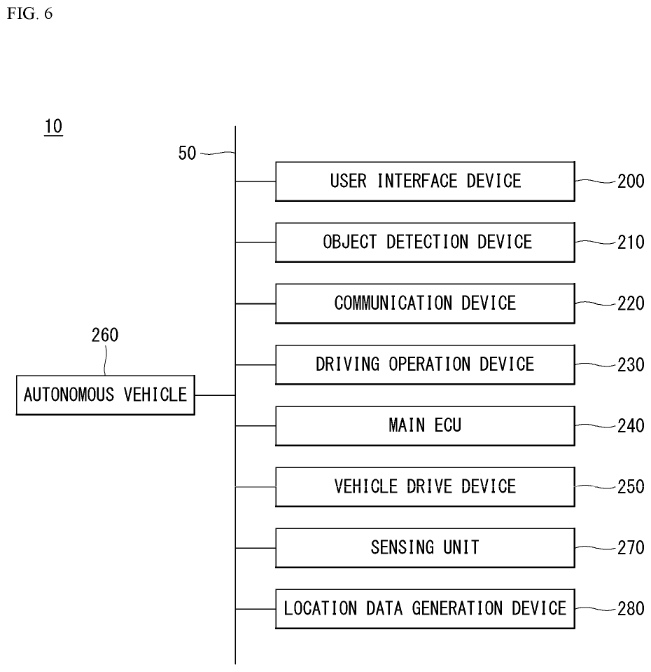

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

According to an embodiment, the vehicle 10 may perform autonomous driving in conjunction with an external device included in an Autonomous Vehicle and Highway System (AVHS). The external device may include a server 20 forming the AVHS, and at least one drone 30. At this point, the vehicle 10 may be an autonomous vehicle or a manually driven vehicle provided without the autonomous device 260.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

According to an embodiment, when the vehicle 10 operates in conjunction with the external device included in the AVHS, the user interface device 200 may provide the user with real-time information of a drone 30 moving to assist autonomous driving of the vehicle 10. In addition, the user interface device 200 may receive the user's input, monitors a state of the user, and transmit a monitoring result to a main ECU 240. The user's input or the monitoring result may be used to detect whether an emergency occurs in the main ECU 240.

The emergency may include a situation where the user is not capable of driving normally. For example, the emergency may include a case where the user dozes off and thereby close his/her eyes or bend his/her head. However, aspects of the present invention are not limited thereto, and the emergency may include any situation where an accident possibility increases due to the user's heath issue.

When the emergency occurs, the main ECU 240 may transmit a driving assist request to request assistance for autonomous driving of the vehicle 10.

The real-time information may include at least one of the following information: a current location of the drone 30, a moving path of the drone 30, and a time required for the drone 30 to arrive at the vehicle 10. The real-time information may be information received from the server 20 or received from the drone 30.

When the user interface device 200 is configured as an element of the vehicle 10 to operate in conjunction with an external device in the AVHS, the user interface device 200 may be referred to as a user interface unit.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

According to an embodiment, when the object detection device 210 is included as an element of the vehicle 10 to operate in conjunction with an external device in the AVHS, the object detection device 210 may be referred to as a sensor unit. The sensor unit may include a plurality of sensors to detect an object located outside the vehicle 10. The sensor unit may periodically transmit, to a controller which will be described later on, states of the plurality of sensors included in the sensor unit.

At this point, the controller may detect an error based on the states of the plurality of sensors.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3) Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

According to an embodiment, when the communication device 220 is included as an element of the vehicle 10 to operate in conjunction with an external device in the AVHS, the communication device 220 may be referred to as a communication unit. The communication unit may transmit or receive a signal related to autonomous driving of the vehicle 10 to or from the outside of the vehicle 10.

Specifically, the communication unit may transmit or receive a signal under control of the controller which will be described later on. The communication unit may receive, from the server 20 included in the AVSH, real-time information of the drone 30 moving to assist autonomous driving of the vehicle 10. In addition, the communication unit may receive a connection request from the drone 30 having approached in proximity of the vehicle 10.

The communication unit may receive information the drone 30 selected by the server 20. Information on the drone 30 may include at least one of the following: ID of the drone 30 selected by the server 20 and a type of the corresponding drone 30. The communication unit may receive an authentication key that is generated by the server 20 to connect the vehicle 10 and the drone 30.

When the drone 30 is electrically connected to the vehicle 10, the communication unit may initiate data transmission and reception for autonomous driving of the vehicle 10. When the drone 30 lands at a landing point provided in the vehicle 10 and thereby connected to the vehicle 10 by a contact-method, the communication unit may transmit and receive the data for autonomous driving through a contact point provided in the landing point. When the drone 30 is connected to the vehicle 10 while hovering in area region formed at a predetermined distance from the vehicle 10 (a non-contact method), the communication unit may wirelessly transmit and receive the data for autonomous driving.

However, aspects of the present invention are not limited thereto, and the method by which the communication transmits and receives the data with respect to the drone 30 may be embodied as any of various methods in consideration of a communication protocol, specification of the vehicle 10 or the drone 30, compatibility of the vehicle 10 or the drone 30, and the like.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

According to an embodiment, when the main ECU 240 and the driving control device 250 are configured as elements of the vehicle 10 to operate in conjunction of an external device included in the AVHS, the main ECU 240 and the driving control device 250 may be formed integrally with each other. At this point, the integrally formed element may be referred to as a controller.

The controller may control driving related to autonomous driving of the vehicle 10 in conjunction with an external device included in the AVHS. The external device may include the server 20 and at least one drone 30. The drone 30 may include at least one sensor to assist autonomous driving of the vehicle 10.

Specifically, the controller may generate a driving assistance request in response to satisfaction of a preset condition or in response to an input of the user, and transmit the driving assistance request to the server 20. The controller may request connection to a drone 30 selected by the server 20 in responses to the driving assistance request. In addition, the controller may authenticate the connection request and thereby initiate data transmission and reception with the drone 30. When the data transmission and reception is initiated, the controller may control driving of the vehicle 10 using autonomous assistance data received from the drone 30.

The driving assistance data may include at least one of the following: first sensor data acquired through a sensor of the drone 30, second sensor data acquired by a sensor of the drone 30 corresponding to a sensor in which an error is detected among the plurality of sensors included in the sensor unit, and an autonomous driving control signal instructing operation of the vehicle 10.

The controller may determine whether to transmit the driving assistance request by using at least one of the following; a state of the sensor unit, a monitoring result of the user interface unit, a signal according to at least one Advanced Driver Assistance System (ADAS) function of an autonomous vehicle 260, and vehicle state data received from the sensing unit 270.

Specifically, when an error in one of the plurality of sensors is detected, when an accident possibility is equal to or higher than a predetermined level, or when occurrence of an emergency is sensed, the controller may transmit the autonomous driving request.

The autonomous assistance request may include at least one of the following: a driving destination, a state of the user, information related to autonomous driving of the vehicle 10, a location of the vehicle 10, and identification information of the vehicle 10.

According to an embodiment, the driving destination may be a location input directly by the user or a destination pre-input as an autonomous driving destination. However, aspects of the present invention are not limited thereto, and the driving destination may be determined by a reason for the driving assistance request. For example, in the case of an emergency where an abnormality occurs in the user's health, the driving destination may be determined as an emergency room of a nearby hospital. At this point, the controller may perform control to transmit information related to the emergency to the corresponding hospital.

According to an embodiment, the state of the user may include at least one of the following: whether the user is drunk, whether the user is injured, whether the user is an elderly person, whether the user is pregnant, and any other information about health of the user.

The Information related to autonomous driving of the vehicle 10 may include at least one of the following: whether the vehicle 10 is capable of traveling, whether the vehicle 10 is involved in an accident, information on a sensor in which the error is detected among the sensors of the vehicle 10, and whether the vehicle 10 supports an autonomous driving function.

The identification information of the vehicle 10 may include at least one of a color, a type, or a licensed number of the vehicle 10. When a landing point for the drone 30 is provided in the vehicle 10, the identification information may further include a location of the landing point in one area of the vehicle 10. The landing point may include at least one contact point that enables electrical connection between the vehicle 10 and the drone 30, and may include a fastening part to fix the drone 30 to the vehicle 10.

The controller may perform control to receive information on the drone 30 selected by the server 20. Specifically, the controller may control the server 20 to receive an authentication key that is generated for connection between the drone 30 and the vehicle 10.

According to an embodiment, the authentication key may be valid before a preset time expires after a generation timing of the authentication key. When a valid period of the authentication key ends, the controller may request update of the authentication key from the server 20 and receive a re-generated authentication key from the server 20.

The controller may receive real-time information related to a location of the drone 30 selected by the server 20 and currently moving toward the vehicle 10, and, when a distance between the drone 30 and the vehicle 10 is equal to or smaller than a predetermined value, the controller may perform control to receive a connection request from the drone 30.

According to an embodiment, the real-time information may include at least one of the following: a current location of the drone 30 and a time required for the drone 30 to arrive at the vehicle 10.

When the connection request is received from the drone 30, the controller may perform control to verify validity of the connection request and transmit connection approval. According to an embodiment the connection request may include at least one of ID of the drone 30 or an authentication key generated by the server 20 for connection with the vehicle 10. The controller may perform control to transmit the connection approval depending on whether the ID of the drone 30 or the authentication key received from the server 20 matches information included in the connection request.

The controller may perform control so that the drone 30 having received the connection approval moves to a preset location and, upon electrical connection with the vehicle 10, initiates data transmission and reception for autonomous driving.

According to an embodiment, the preset location may be a landing point provided at an exterior of the vehicle 10 or a location in a region formed at a predetermined distance from the vehicle 10. The preset distance may be set to a specific value in consideration of a data speed required to perform the autonomous driving, a degree of convenience to acquire e sensor data to assist the autonomous driving of the vehicle 10, and the like.

When the data transmission and reception is initiated, the controller may perform control to transmit, to the drone 30, information on fuel of the vehicle 10, information on a remaining battery capacity of the vehicle 10, or any other real-time information of the vehicle 10 related to autonomous driving.

The controller may control driving of the vehicle 10 using data received from the drone 30, depending on whether the vehicle 10 supports an autonomous driving function.

Specifically, when the autonomous driving vehicle 260 is provided in the vehicle 10, the controller may control driving of the vehicle 10 by using at least one of the following: sensor data acquired through a sensor normally operating among the plurality of sensors included in the sensor unit, the first sensor data, and the second sensor data. In this case, the controller controls driving of the vehicle 10 according to an autonomous driving pass generated by the autonomous device 260. The controller may replace an object detection area by a sensor having detected an error with sensor data (the first sensor data or the sensor data) received from the drone 30.

When the vehicle is a manually driven vehicle in which the autonomous driving vehicle 260 is not provided, the controller controls driving of the vehicle 10 in accordance with an autonomous driving control signal received from the drone 30. At this point, the vehicle 10 is not capable of performing autonomous driving by itself, and thus, the drone 30 generating the autonomous driving signal has an autonomous driving control authority. That is, autonomous driving of the vehicle 10 may be performed as the controller generates a signal for controlling each element of the vehicle 10 in accordance with the autonomous driving control signal.

According to an embodiment, the autonomous driving control signal may be a signal that indicates an operation of vehicular elements related to at least one of the following: turning on/off ignition, a driving speed, gear shift, an engine RPM, turning on/off a head light, turning on/off a turn signal, and lane change.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

According to an embodiment, the autonomous device 260 may generate a pass for autonomous driving based on at least one of sensor data acquired through a sensor normally operating among the plurality of sensors included in the sensor unit, the first sensor data, or the second sensor data under control of the controller. The autonomous device 260 may transmit a signal according to at least one ADAS function to the controller. The controller may determine an accident possibility using the corresponding signal.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

According to an embodiment, the sensing unit 270 may transmit the vehicles state data to the controller. The controller may determine an accident possibility using the vehicle state data.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

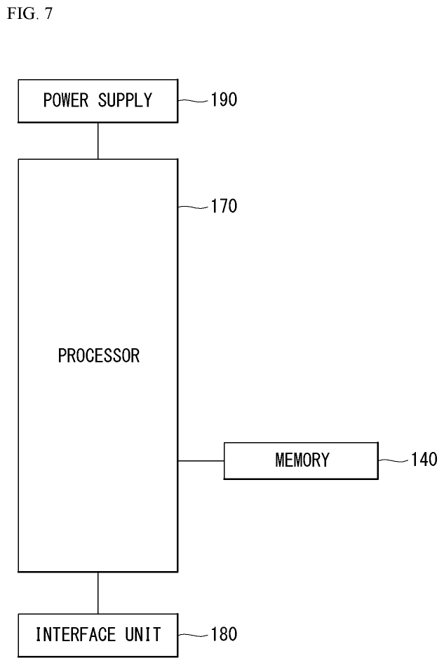

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Cabin

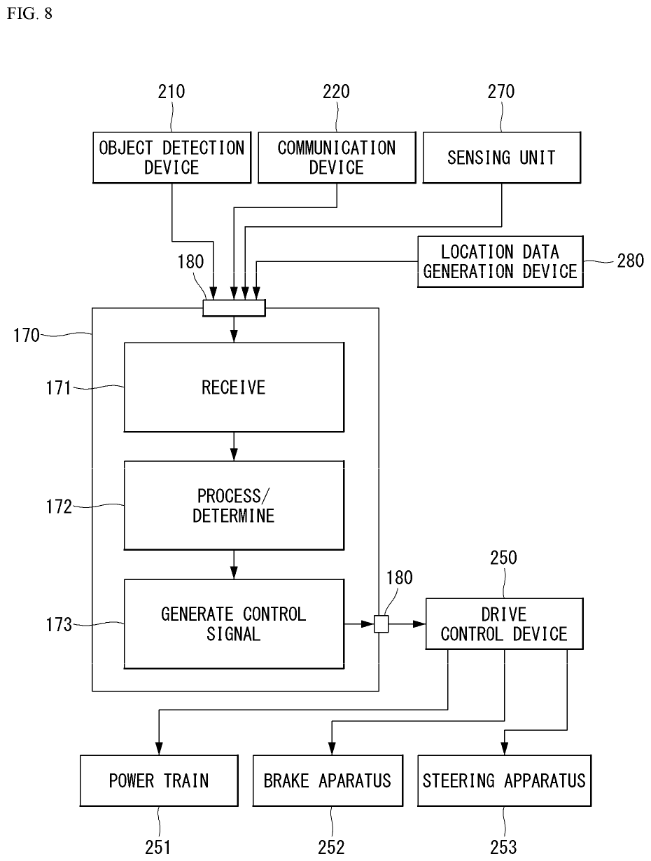

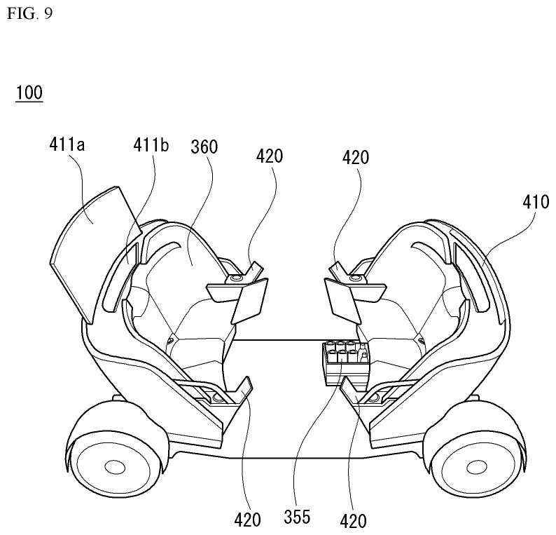

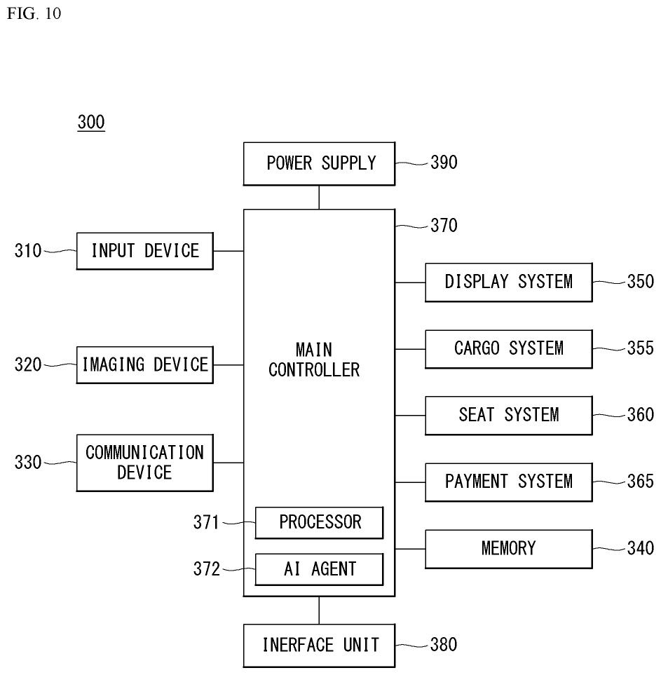

FIG. 9 is a diagram showing the interior of the vehicle according to an embodiment of the present invention. FIG. 10 is a block diagram referred to in description of a cabin system for a vehicle according to an embodiment of the present invention.

(1) Components of Cabin

Referring to FIGS. 9 and 10, a cabin system 300 for a vehicle (hereinafter, a cabin system) can be defined as a convenience system for a user who uses the vehicle 10. The cabin system 300 can be explained as a high-end system including a display system 350, a cargo system 355, a seat system 360 and a payment system 365. The cabin system 300 may include a main controller 370, a memory 340, an interface 380, a power supply 390, an input device 310, an imaging device 320, a communication device 330, the display system 350, the cargo system 355, the seat system 360 and the payment system 365. The cabin system 300 may further include components in addition to the components described in this specification or may not include some of the components described in this specification according to embodiments.

1) Main Controller

The main controller 370 can be electrically connected to the input device 310, the communication device 330, the display system 350, the cargo system 355, the seat system 360 and the payment system 365 and exchange signals with these components. The main controller 370 can control the input device 310, the communication device 330, the display system 350, the cargo system 355, the seat system 360 and the payment system 365. The main controller 370 may be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The main controller 370 may be configured as at least one sub-controller. The main controller 370 may include a plurality of sub-controllers according to an embodiment. The plurality of sub-controllers may individually control the devices and systems included in the cabin system 300. The devices and systems included in the cabin system 300 may be grouped by function or grouped on the basis of seats on which a user can sit.

The main controller 370 may include at least one processor 371. Although FIG. 6 illustrates the main controller 370 including a single processor 371, the main controller 371 may include a plurality of processors. The processor 371 may be categorized as one of the above-described sub-controllers.

The processor 371 can receive signals, information or data from a user terminal through the communication device 330. The user terminal can transmit signals, information or data to the cabin system 300.

The processor 371 can identify a user on the basis of image data received from at least one of an internal camera and an external camera included in the imaging device. The processor 371 can identify a user by applying an image processing algorithm to the image data. For example, the processor 371 may identify a user by comparing information received from the user terminal with the image data. For example, the information may include at least one of route information, body information, fellow passenger information, baggage information, position information, preferred content information, preferred food information, disability information and use history information of a user.

The main controller 370 may include an artificial intelligence (AI) agent 372. The AI agent 372 can perform machine learning on the basis of data acquired through the input device 310. The AI agent 371 can control at least one of the display system 350, the cargo system 355, the seat system 360 and the payment system 365 on the basis of machine learning results.

2) Essential Components

The memory 340 is electrically connected to the main controller 370. The memory 340 can store basic data about units, control data for operation control of units, and input/output data. The memory 340 can store data processed in the main controller 370. Hardware-wise, the memory 340 may be configured using at least one of a ROM, a RAM, an EPROM, a flash drive and a hard drive. The memory 340 can store various types of data for the overall operation of the cabin system 300, such as a program for processing or control of the main controller 370. The memory 340 may be integrated with the main controller 370.

The interface 380 can exchange signals with at least one electronic device included in the vehicle 10 in a wired or wireless manner. The interface 380 may be configured using at least one of a communication module, a terminal, a pin, a cable, a port, a circuit, an element and a device.

The power supply 390 can provide power to the cabin system 300. The power supply 390 can be provided with power from a power source (e.g., a battery) included in the vehicle 10 and supply the power to each unit of the cabin system 300. The power supply 390 can operate according to a control signal supplied from the main controller 370. For example, the power supply 390 may be implemented as a switched-mode power supply (SMPS).

The cabin system 300 may include at least one printed circuit board (PCB). The main controller 370, the memory 340, the interface 380 and the power supply 390 may be mounted on at least one PCB.

3) Input Device

The input device 310 can receive a user input. The input device 310 can convert the user input into an electrical signal. The electrical signal converted by the input device 310 can be converted into a control signal and provided to at least one of the display system 350, the cargo system 355, the seat system 360 and the payment system 365. The main controller 370 or at least one processor included in the cabin system 300 can generate a control signal based on an electrical signal received from the input device 310.

The input device 310 may include at least one of a touch input unit, a gesture input unit, a mechanical input unit and a voice input unit. The touch input unit can convert a user's touch input into an electrical signal. The touch input unit may include at least one touch sensor for detecting a user's touch input. According to an embodiment, the touch input unit can realize a touch screen by integrating with at least one display included in the display system 350. Such a touch screen can provide both an input interface and an output interface between the cabin system 300 and a user. The gesture input unit can convert a user's gesture input into an electrical signal. The gesture input unit may include at least one of an infrared sensor and an image sensor for detecting a user's gesture input. According to an embodiment, the gesture input unit can detect a user's three-dimensional gesture input. To this end, the gesture input unit may include a plurality of light output units for outputting infrared light or a plurality of image sensors. The gesture input unit may detect a user's three-dimensional gesture input using TOF (Time of Flight), structured light or disparity. The mechanical input unit can convert a user's physical input (e.g., press or rotation) through a mechanical device into an electrical signal. The mechanical input unit may include at least one of a button, a dome switch, a jog wheel and a jog switch. Meanwhile, the gesture input unit and the mechanical input unit may be integrated. For example, the input device 310 may include a jog dial device that includes a gesture sensor and is formed such that it can be inserted/ejected into/from a part of a surrounding structure (e.g., at least one of a seat, an armrest and a door). When the jog dial device is parallel to the surrounding structure, the jog dial device can serve as a gesture input unit. When the jog dial device is protruded from the surrounding structure, the jog dial device can serve as a mechanical input unit. The voice input unit can convert a user's voice input into an electrical signal. The voice input unit may include at least one microphone. The voice input unit may include a beam forming MIC.

4) Imaging Device

The imaging device 320 can include at least one camera. The imaging device 320 may include at least one of an internal camera and an external camera. The internal camera can capture an image of the inside of the cabin. The external camera can capture an image of the outside of the vehicle. The internal camera can acquire an image of the inside of the cabin. The imaging device 320 may include at least one internal camera. It is desirable that the imaging device 320 include as many cameras as the number of passengers who can ride in the vehicle. The imaging device 320 can provide an image acquired by the internal camera. The main controller 370 or at least one processor included in the cabin system 300 can detect a motion of a user on the basis of an image acquired by the internal camera, generate a signal on the basis of the detected motion and provide the signal to at least one of the display system 350, the cargo system 355, the seat system 360 and the payment system 365. The external camera can acquire an image of the outside of the vehicle. The imaging device 320 may include at least one external camera. It is desirable that the imaging device 320 include as many cameras as the number of doors through which passengers ride in the vehicle. The imaging device 320 can provide an image acquired by the external camera. The main controller 370 or at least one processor included in the cabin system 300 can acquire user information on the basis of the image acquired by the external camera. The main controller 370 or at least one processor included in the cabin system 300 can authenticate a user or acquire body information (e.g., height information, weight information, etc.), fellow passenger information and baggage information of a user on the basis of the user information.

5) Communication Device

The communication device 330 can exchange signals with external devices in a wireless manner. The communication device 330 can exchange signals with external devices through a network or directly exchange signals with external devices. External devices may include at least one of a server, a mobile terminal and another vehicle. The communication device 330 may exchange signals with at least one user terminal. The communication device 330 may include an antenna and at least one of an RF circuit and an RF element which can implement at least one communication protocol in order to perform communication. According to an embodiment, the communication device 330 may use a plurality of communication protocols. The communication device 330 may switch communication protocols according to a distance to a mobile terminal.

For example, the communication device can exchange signals with external devices on the basis of C-V2X (Cellular V2X). For example, C-V2X may include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

6) Display System

The display system 350 can display graphic objects. The display system 350 may include at least one display device. For example, the display system 350 may include a first display device 410 for common use and a second display device 420 for individual use.

6.1) Common Display Device

The first display device 410 may include at least one display 411 which outputs visual content. The display 411 included in the first display device 410 may be realized by at least one of a flat panel display, a curved display, a rollable display and a flexible display. For example, the first display device 410 may include a first display 411 which is positioned behind a seat and formed to be inserted/ejected into/from the cabin, and a first mechanism for moving the first display 411. The first display 411 may be disposed such that it can be inserted/ejected into/from a slot formed in a seat main frame. According to an embodiment, the first display device 410 may further include a flexible area control mechanism. The first display may be formed to be flexible and a flexible area of the first display may be controlled according to user position. For example, the first display device 410 may be disposed on the ceiling inside the cabin and include a second display formed to be rollable and a second mechanism for rolling or unrolling the second display. The second display may be formed such that images can be displayed on both sides thereof. For example, the first display device 410 may be disposed on the ceiling inside the cabin and include a third display formed to be flexible and a third mechanism for bending or unbending the third display. According to an embodiment, the display system 350 may further include at least one processor which provides a control signal to at least one of the first display device 410 and the second display device 420. The processor included in the display system 350 can generate a control signal on the basis of a signal received from at last one of the main controller 370, the input device 310, the imaging device 320 and the communication device 330.

A display area of a display included in the first display device 410 may be divided into a first area 411a and a second area 411b. The first area 411a can be defined as a content display area. For example, the first area 411 may display at least one of graphic objects corresponding to can display entertainment content (e.g., movies, sports, shopping, food, etc.), video conferences, food menu and augmented reality screens. The first area 411a may display graphic objects corresponding to traveling situation information of the vehicle 10. The traveling situation information may include at least one of object information outside the vehicle, navigation information and vehicle state information. The object information outside the vehicle may include information on presence or absence of an object, positional information of an object, information on a distance between the vehicle and an object, and information on a relative speed of the vehicle with respect to an object. The navigation information may include at least one of map information, information on a set destination, route information according to setting of the destination, information on various objects on a route, lane information and information on the current position of the vehicle. The vehicle state information may include vehicle attitude information, vehicle speed information, vehicle tilt information, vehicle weight information, vehicle orientation information, vehicle battery information, vehicle fuel information, vehicle tire pressure information, vehicle steering information, vehicle indoor temperature information, vehicle indoor humidity information, pedal position information, vehicle engine temperature information, etc. The second area 411b can be defined as a user interface area. For example, the second area 411b may display an AI agent screen. The second area 411b may be located in an area defined by a seat frame according to an embodiment. In this case, a user can view content displayed in the second area 411b between seats. The first display device 410 may provide hologram content according to an embodiment. For example, the first display device 410 may provide hologram content for each of a plurality of users such that only a user who requests the content can view the content.

6.2) Display Device for Individual Use

The second display device 420 can include at least one display 421. The second display device 420 can provide the display 421 at a position at which only an individual passenger can view display content. For example, the display 421 may be disposed on an armrest of a seat. The second display device 420 can display graphic objects corresponding to personal information of a user. The second display device 420 may include as many displays 421 as the number of passengers who can ride in the vehicle. The second display device 420 can realize a touch screen by forming a layered structure along with a touch sensor or being integrated with the touch sensor. The second display device 420 can display graphic objects for receiving a user input for seat adjustment or indoor temperature adjustment.

7) Cargo System

The cargo system 355 can provide items to a user at the request of the user. The cargo system 355 can operate on the basis of an electrical signal generated by the input device 310 or the communication device 330. The cargo system 355 can include a cargo box. The cargo box can be hidden in a part under a seat. When an electrical signal based on user input is received, the cargo box can be exposed to the cabin. The user can select a necessary item from articles loaded in the cargo box. The cargo system 355 may include a sliding moving mechanism and an item pop-up mechanism in order to expose the cargo box according to user input. The cargo system 355 may include a plurality of cargo boxes in order to provide various types of items. A weight sensor for determining whether each item is provided may be embedded in the cargo box.

8) Seat System

The seat system 360 can provide a user customized seat to a user. The seat system 360 can operate on the basis of an electrical signal generated by the input device 310 or the communication device 330. The seat system 360 can adjust at least one element of a seat on the basis of acquired user body data. The seat system 360 may include a user detection sensor (e.g., a pressure sensor) for determining whether a user sits on a seat. The seat system 360 may include a plurality of seats on which a plurality of users can sit. One of the plurality of seats can be disposed to face at least another seat. At least two users can set facing each other inside the cabin.

9) Payment System

The payment system 365 can provide a payment service to a user. The payment system 365 can operate on the basis of an electrical signal generated by the input device 310 or the communication device 330. The payment system 365 can calculate a price for at least one service used by the user and request the user to pay the calculated price.

(2) Autonomous Vehicle Usage Scenarios

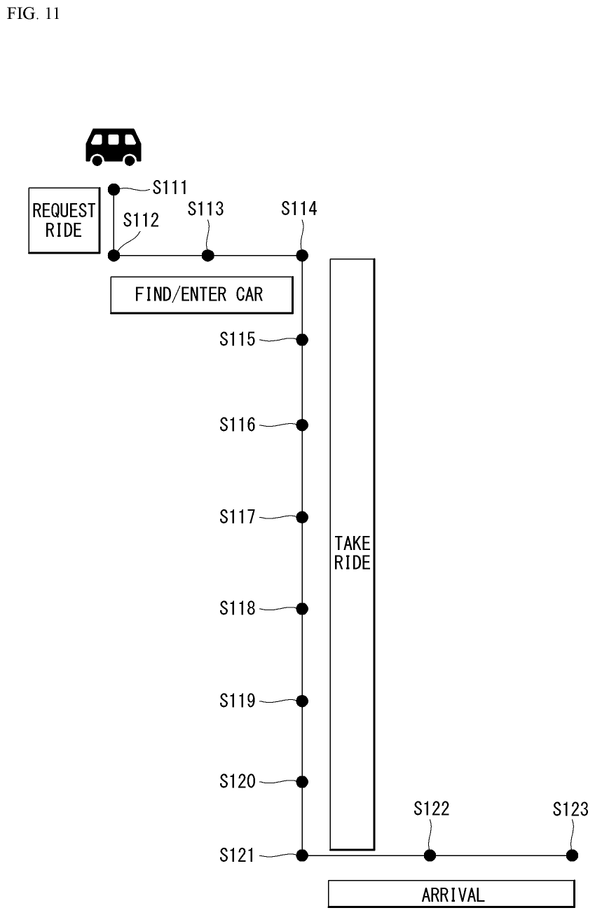

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

### DESCRIPTION OF THE PRESENT INVENTION

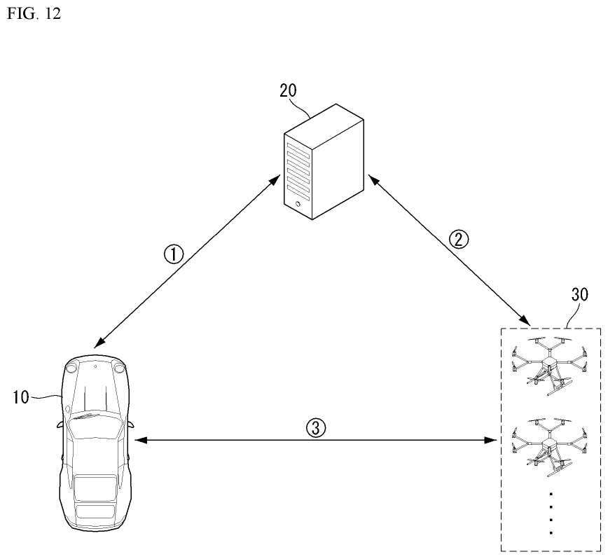

Hereinafter, an Autonomous Vehicle and Highway System (AVHS) and a vehicle included in the same according to an embodiment will be described with reference to FIGS. 12 to 24.

FIG. 12 is a diagram for explaining a configuration of an AVHS according to an embodiment of the present invention.

Referring to FIG. 12, an AVHS according to an embodiment of the present invention may include a server 20 and a drone 30.

The vehicle 10 may request driving assistance from the server 20 to receive assistance of autonomous driving. The vehicle 10 may perform autonomous driving using driving-related assistance data received from the drone 30 selected by the server 20. The driving assistance request may include a driving destination, a state of a user, information related to autonomous driving of the vehicle 10, a location of the vehicle 10, or identification information of the vehicle 10.

According to an embodiment, the state of the user may include at least one of the following information: whether the user is drunk, whether the user is injured, whether the user is pregnant, and any other information related to health of the user.

According to an embodiment, the information related to the autonomous driving of the vehicle may include at least one of the following: whether the vehicle is allowed to travel, whether an accident occurs with respect to the vehicle, information on a sensor in which the error is detected among sensors of the vehicle, and whether the vehicle supports an autonomous driving function.

According to an embodiment of the present invention, the identification information of the vehicle 10 may include at least one of a color, a type, or a licensed number of the vehicle 10.

According to an embodiment, the vehicle may transmit a driving assistance request to the server 20 in response to satisfaction of a preset condition or in response to manipulation of the user. Specifically, when an error in one of the plurality of sensors is detected, when an accident possibility is equal to or higher than a predetermined level, or when occurrence of an emergency is sensed, the vehicle 10 may transmit the autonomous driving request. The emergency may include a situation where the user is not capable of driving normally. For example, the emergency may include a case where the user dozes off and thereby close his/her eyes or bend his/her head.

However, aspects of the present invention are not limited thereto, and the vehicle 10 may transmit the driving assistance request in any situation where an accident possibility increases. Even in a case where the user is not able to recognize a dangerous situation directly, the driving assistance request can be transmitted and therefore an accident possibility can be reduced.

The vehicle 10 may receive information on the drone 30 from the server 20. The information on the drone 30 may include at least one of ID or a type of the drone 30 selected by the server 20.

The vehicle 10 may receive an authentication key generated by the server 20. The authentication key may be generated by the server 20 for connection with the vehicle 10. The authentication key may be valid only before a preset time expires since a generation timing of the authentication key. When a valid period of the authentication key ends, the vehicle 10 may request update of the authentication key from the server 20 and receive a re-generated authentication key from the server 20.

The vehicle 10 may receive real-time information from the server 20. The real-time information may be information related to a location of the drone 30 selected by the server 20. Specifically, the real-time information may include at least one of a current location of the drone 30 or a time required for the drone 30 to arrive at the vehicle 10.

The vehicle 10 may verify a connection request from the drone 30 and thereby initiate data transmission and reception for autonomous driving.

The vehicle 10 may receive the connection request from the drone 30 which has approached within a predetermined distance from the vehicle 10. Specifically, when the drone 30 selected by the server 20 approaches within the predetermined distance and transmits the connection request, the vehicle 10 may verify validity of the connection request and transmit connection approval. According to an embodiment the connection request may include at least one of ID of the drone 30 or an authentication key generated by the server 20 for connection with the vehicle 10. The vehicle 10 may perform control to transmit the connection approval depending on whether the ID of the drone 30 or the authentication key received from the server 20 matches information included in the connection request.

When the drone 30 having received the connection approval moves to a preset location and thereby electrically connected to the vehicle 10, the vehicle 10 may initiate the data transmission and reception for autonomous driving. According to an embodiment, the preset location may be a landing point provided at an exterior of the vehicle 10 or a location in a region formed at a predetermined distance from the vehicle 10. The preset distance may be set to a specific value in consideration of a data speed required to perform the autonomous driving, a degree of convenience to acquire e sensor data to assist the autonomous driving of the vehicle 10, and the like.

The vehicle 10 may be an autonomous vehicle or a manually driven vehicle. The vehicle 10 may perform the autonomous driving using driving assistance data received from the drone 30. The driving assistance data may include at least one of the following: first sensor data acquired through a sensor of the drone 30, second sensor data acquired by a sensor of the drone 30 corresponding to a sensor in which an error is detected among the plurality of sensors included in the sensor unit, and an autonomous driving control signal instructing operation of the vehicle 10.

When the vehicle is an autonomous vehicle supporting an autonomous driving function, the vehicle 10 may perform autonomous driving using at least one of the following: sensor data acquired through sensors normally operating sensors among sensors provided in the vehicle, the first sensor data, and the second sensor data.

When the vehicle 10 is a manually driven vehicle not supporting the autonomous driving function, the vehicle 10 operates in accordance with the autonomous driving control signal received from the drone 30. Specifically, at least one element related to the autonomous driving control signal among elements of the vehicle 10 operates.

According to an embodiment, when the vehicle 10 arrives at a destination, the vehicle 10 may transmit a request to the server 20 to release connection with the drone 30.

The server 20 may assign the drone 30 to assist autonomous driving of the vehicle 10.

The server 20 may receive the driving assistance request from the vehicle 10. The server 20 may assign the drone 30 based on information acquired using the driving assistance request. The server 20 may transmit information on the drone 30 to the vehicle 10. The information on the drone 30 may include ID of the drone 30, a model of the drone 30, and any other information related to identification of the drone 30.

According to an embodiment, the server 20 may select any one drone 30 capable of assisting driving of the vehicle 10 from among a plurality of registered drones by a preset standard in response to the driving assistance request.

Specifically, the server 20 may select a drone 30 for assisting driving of the vehicle 10 by considering at least one of the following: a degree of adjacency of each drone included in the plurality of drones to the vehicle 10, whether a sensor necessary for the vehicle 10 is provided, and a remaining battery capacity required to assist autonomous driving of the vehicle 10.

The server 20 may transmit location information of the vehicle 10 to a drone 30 assigned for the vehicle 10 which has transmitted the driving assistance request. According to an embodiment, when receiving a response as to the location information from the drone 30, the server 20 may instruct the drone 30 to move with respect to the vehicle 10.

Even while the drone 30 is moving toward the vehicle 10, the server 20 may maintain a connection session. At this point, the server 20 may receive real-time information related to a location of the drone 30. The server 20 may transmit the real-time information to the vehicle 10.

According to an embodiment, the server 20 may generate an authentication key to connect the vehicle 10 and the drone 30. The server 20 may transmit the authentication key to the vehicle 10 and the drone 30. The authentication key may be set to be valid only before a preset valid time expires since a generation timing of the authentication key. For example, the authentication key may be set to be automatically discarded or become ineffective when the valid period ends.

A length of the preset valid period may be determined by a time required for the drone 30 to arrive at the vehicle 10.

When the valid time of the authentication key expires, the server 20 may receive an update request and re-generate the authentication key. The server 20 may transmit the re-generated authentication key to the vehicle 10 and the drone 30.

When a connection release request is received from the vehicle 10 which has arrived at a destination, the server 20 may transmit a state information request for connection release to the drone 30 that is connected to the vehicle 10.

The state information for connection release may include at least one of the following: a current location of the vehicle 10, a surrounding image of the vehicle 10, a current location of the drone 30, a remaining battery capacity of the drone 30, and any other state information related to a driving assistance operation of the drone 30. The server 20 may periodically receive the state information for a predetermined time.

The server 20 may transmit a connection release response to the drone 30 which has transmitted the state information. The connection release response may include information that instructs an operation. According to an embodiment, the server 20 may determine whether safety of the vehicle 10 is ensured, based on the state information for the connection release, may generate a connection release response corresponding to a result of the determination, and transmits the result of the determination. The connection release response may include location information of another vehicle 10.

The drone 30 may assist autonomous driving of the vehicle 10. Specifically, the drone 30 may include at least one sensor to assist autonomous driving of the vehicle 10 which has transmitted the driving assistance request.

The drone 30 may receive location information of the vehicle 10 from the server 20. The drone 30 may initiate movement toward the vehicle 10 based on the location information. The location information may include a location of a landing point provided in the vehicle 10. According to an embodiment, the drone 30 may transmit, to the server 20, a response message about whether the location information is received. When an instruction to move to the vehicle 10 is received from the server 20, the drone 30 may initiate movement toward the vehicle 10.

After approaching toward the vehicle 10 based on the location information, the drone 30 may transmit a connection request to the vehicle 10 to assist autonomous driving of the vehicle 10. According to an embodiment of the present invention, the drone 30 may receive, from the vehicle 10, a connection approval which is a response to the connection request. When the connection approval is received, the drone 30 may move to the preset location. When the drone 30 and the vehicle 10 are electrically connected, the drone 30 may transmit the autonomous assistance data to the vehicle.

When the vehicle 10 arrives at a destination, the drone 30 may receive, from the server 20, a state information request for connection release. The drone 30 may transmit or periodically transmit the state information for connection release to the server 20. By receiving a connection release response from the server 20, the drone 30 may perform an operation according to the connection release response. A detailed description thereof is provided in the following.

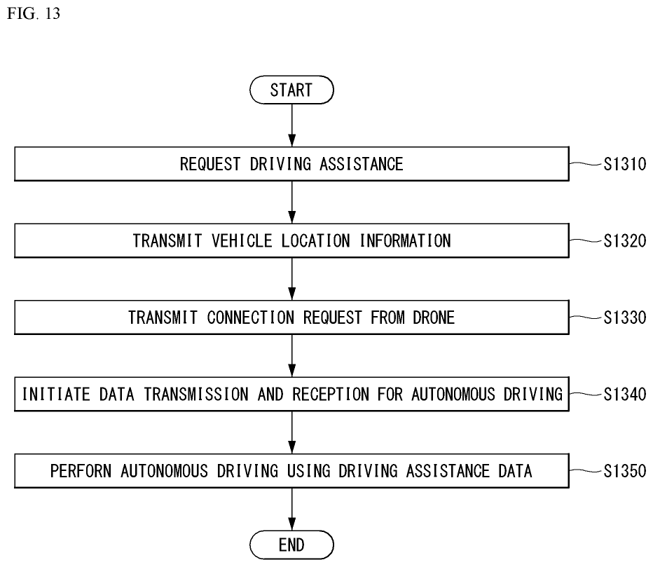

Hereinafter, FIGS. 13 to 17 explain embodiments of the present invention in terms of a control method of the AVHS including the vehicle 10, the server 20, and the drone 30.

FIG. 13 is a flowchart for explaining a control method of an AVHS according to an embodiment of the present invention.

Referring to FIG. 13, a control method of an AVHS according to an embodiment of the present invention may include a step S1310 to request driving assistance, a step S1320 to transmit location information of the vehicle, a step S1330 of request connection by a drone, a step S1340 to initiate data transmission and reception for autonomous driving, and a step S1350 to perform autonomous driving using the driving assistance data.

In the step S1310, the vehicle transmits an assistance request to the server 20 in response to satisfaction of a preset condition or in response to an input of a user.

According to an embodiment, when an error in one of the plurality of sensors is detected, when an accident possibility is equal to or higher than a predetermined level, or when occurrence of an emergency is sensed, the vehicle 10 may transmit the autonomous driving request. The emergency may include a situation where the user is not capable of driving normally. For example, the emergency may include a case where the user dozes off and thereby close his/her eyes or bend his/her head.

However, aspects of the present invention are not limited thereto, and the vehicle 10 may transmit the driving assistance request in any situation where an accident possibility increases. Even in a case where the user is not able to recognize a dangerous sitaution directly, the driving assistance request can be transmitted and therefore an accidence probability can be reduced.

According to an embodiment, the vehicle 10 may determine the accident possibility using at least one of the following: a monitoring result of the user, a signal according to at least one ADAS function related to autonomous driving, and vehicle state data related to a state of the vehicle 10.

According to an embodiment, the autonomous assistance request may include at least one of the following: a driving destination, a state of the user, information related to autonomous driving of the vehicle 10, a location of the vehicle 10, and identification information of the vehicle 10.

According to an embodiment, the state of the user may include at least one of the following: whether the user is drunk, whether the user is injured, whether the user is an elderly person, whether the user is pregnant, and any other information about health of the user.

The information related to autonomous driving of the vehicle 10 may include at least one of the following: whether the vehicle 10 is capable of traveling, whether the vehicle 10 is involved in an accident, information on a sensor in which the error is detected among the sensors of the vehicle 10, and whether the vehicle 10 supports an autonomous driving function.

The identification information of the vehicle 10 may include at least one of a color, a type, or a licensed number of the vehicle 10.

In the step S1320, the server 20 transmits location information of the vehicle 10 to a drone 30 having a sensor configured to assist autonomous driving of the vehicle 10. According to an embodiment, the server 20 may select a drone 30 capable of assisting driving of the vehicle 10, which has transmitted the driving assistance request, and may transmit the location information of the vehicle 10 to the selected drone 30.

In the step S1330, the drone 30 transmits a connection request. Specifically, the drone 30 having received the location information of the vehicle 10 from the server 20 approaches toward the vehicle 10 and transmits the connection request to the vehicle 10.

According to an embodiment, when receiving the location information of the vehicle 10 from the server 20, the drone 30 may transmit, to the server 20, a response as to whether the location information is received. The response as to whether location information is received may include information related to a current state of the drone 30. The information on the current state of the drone 30 may include at least one of the following: a current location of the drone 30, a type of sensor provided in the drone 30, and a remaining battery capacity.

When a message instructing movement is received from the server 20 having received the response as to whether location information is received, the drone 30 may initiate movement toward the vehicle 10.

In the step S1340, the vehicle 10 may authenticate the connection request to initiate data transmission and reception for the autonomous driving. Specifically, after verifying validity of the connection request, the vehicle 10 may initiate data transmission and reception for the autonomous driving. The connection request may include ID or an authentication key of the drone 30. The authentication key may be generated by the server 20 to connect the vehicle 10 and the drone 30.

In the step S1350, the vehicle 10 may perform the autonomous driving based on driving assistance data received from the drone 30. The driving assistance data may include at least one of the following: first sensor data acquired through a sensor of the drone 30, second sensor data acquired by a sensor of the drone 30 corresponding to a sensor in which an error is detected among the plurality of sensors included in the sensor unit, and an autonomous driving control signal instructing operation of the vehicle 10.

According to an embodiment of the present invention, the control method of the AVHS may further include a step to request connection release.

The step to request connection release may include transmitting, by the vehicle 10, a connection release request to the server 20, transmitting, by the server 20, a state information request for the connection release to the drone 30, transmitting, by the drone 30, state information for the connection release to the server 20, and transmitting, by the server 20, a connection release response to the drone 30.

In the transmitting of the connection release request, the vehicle 10 may transmit the connection release request to the server 20 to disconnect from the drone 30 when the vehicle 10 arrives at a destination according to the driving assistance request.

The transmitting of the state information request, the server 20 may request state information to the drone 30 connected to the vehicle 10.

In the transmitting of the state information, the drone 30 having received the connection release request may transmit state information for the connection release to the server 20. The drone 30 may periodically transmit state information for the connection release to the server 20.

According to an embodiment, the state information for connection release may include at least one of the following: a current location of the vehicle 10, a surrounding image of the vehicle 10, a current location of the drone 30, a remaining battery capacity of the drone 30, and any other state information related to a driving assistance operation of the drone 30. The state information for the connection release may further include information as to whether safety of the vehicle 10 is ensured.

In the transmission of the connection release response, the server 20 may transmit a connection release message instructing release of connection with the vehicle 10 to the drone 30.

According to an embodiment, the server 20 may use the state information to determine whether safety of the vehicle 10 is ensured. The server 20 may set to transmit the connection release response only when safety of the vehicle 10 is ensured.

When it is determined based on the periodically received state information that no accident possibility is found in the surroundings of the vehicle 10 for a time or the vehicle 10 is parked in a parking area, the server 20 may determine that safety of the vehicle 10 is ensured. According to another embodiment, the server 20 may transmit the connection release response after verifying information as to whether safety of the vehicle 10 is ensured, the information which is included in the state information.

According to an embodiment, the connection release response may include information instructing an operation of the drone 30. The server 20 may use the state information to determine as to whether safety of the vehicle 10 is ensured, and transmit the connection release response according to the determination.

When safety of the vehicle 10 is not ensured, the connection release response according to the determination may include information that instructs a control operation so that the vehicle 10 moves to a safe place. Specifically, the connection release response may include information that instructs generating an autonomous driving control signal to control the vehicle 10 to move to a specific location. The specific location may be a location at which no object is detected for a predetermined time in a specific region formed around the vehicle 10, or the specific location may be a parking area closest to the current location of the vehicle 10.

When safety of the vehicle 10 is ensured, the connection release response according to the determination may include information instructing release of connection with the vehicle 10. At this point, the disconnection response may further include location information of another vehicle 10.

According to an embodiment, the server 20 may instruct the connection release through the connection release response, and may instruct, at the same time, an additional operation according to a state of the drone 30 which is discovered through the state information.

Specifically, the server 20 may instruct at least one of the following operations according to a state of the drone 30: 1) moving according to location information of another vehicle 10 to assist driving of the another vehicle 10, 2) moving to a charging station close to the current location of the vehicle 10 to charge, and 3) returning back to an original location of the drone 30. The connection release response according to the determination may further include the 1) to 3) operations in addition to information instructing release of connection.

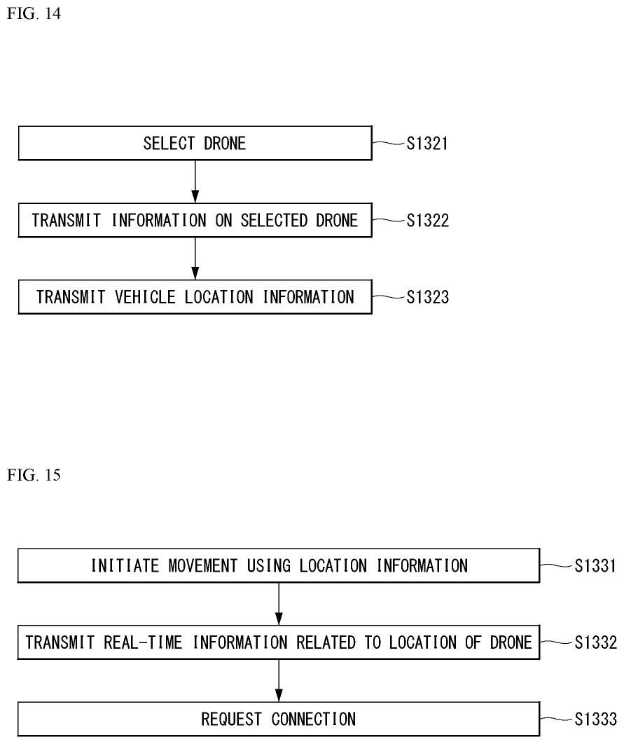

Hereinafter, FIGS. 14 to 17 explain in detail each step of an AVHS according to an embodiment of the present invention.

FIG. 14 is a flowchart for explaining in detail a step to transmit location information of a vehicle in a control method of an AVHS according to an embodiment of the present invention.

Referring to FIG. 14, the step S1320 to transmit location information of a vehicle according to an embodiment of the present invention may include a step S1321 to select a drone, a step S1322 to transmit information on the selected drone, and a step S1323 to transmit location information of the vehicle.

In the step S1321, the server 20 selects any one drone from a plurality of drones 30 by a preset standard. The plurality of drones 30 may be drones 30 pre-registered in the server 20.

According to an embodiment, the server 20 may select any one of the plurality of drones by considering at least one of the following: a degree of adjacency to the vehicle 10, whether a sensor necessary for the vehicle 10 is provided, and a remaining battery capacity required to assist autonomous driving of the vehicle 10.

In the step S1322, the server 20 transmits information on a selected drone 30 to the vehicle. According to an embodiment, the server 20 may generate an authentication key and transmit the authentication key to the vehicle 10 and the selected drone 30. The authentication key may be valid only before a preset valid time expires since a generation timing.

A length of the preset valid period may be determined by a time required for the drone 30 to arrive at the vehicle 10. For example, when the selected drone 30 needs five minutes to arrive at the vehicle 10, the length of the preset valid period may be six minutes.

However, aspects of the present invention are not limited thereto, and the length of the preset valid period may be set to a different value by taking all into consideration a time required to connect the vehicle 10 and the drone 30, any other communication environment, a level of security set in the vehicle 10, and the like.

According to an embodiment, when the valid time of the authentication key expires, the server 20 may receive an authentication key update request from the vehicle 10. The server 20 may transmit a re-generated authentication key to the vehicle 10 and the drone 30.

According to another embodiment of the present invention, in a case where the valid time expires even though there is no authentication update request from the vehicle 10, the server 20 may re-generate the authentication key and transmit the re-generated authentication key to the vehicle 10 and the drone 30. The authentication key of which valid time expires may be set to be automatically discarded in the vehicle 10 or the drone 30, or, when a new authentication key is received, a previous authentication key may be set to be discarded.

In the step S1323, the server 20 may transmit location information of the vehicle 10 to the selected drone 30.

Based on the location information, the drone 30 may move to the vehicle 10 which has transmitted the driving assistance request.

According to an embodiment, the server 20 may receive, from the drone 30, a response as to whether the location information of the vehicle 10 is received. When receiving the response as to whether the location information is received, the server 20 may transmit, to the corresponding drone 30, a message that instructs moving to the vehicle based on the location information. The drone 30 may initiate movement after receiving the message.

It is described that the step S1320 follows the step S1322, but this is merely an example for convenience of explanation, and the principal of the present invention is not limited to the corresponding order. The above-described steps S1322 and S1323 may be performed in a different order or may be performed at the same time in parallel after the step S1321.

The above-described embodiment (S1321 to S1324) is described in the assumption that the server 20 transmits the location information of the vehicle 10 only to any one drone 30, but the location information of the vehicle 10 may be transmitted to the plurality of drones 30 according to another embodiment.

Specifically, when receiving a driving assistance request from the vehicle 10, the server 20 may broadcast the location information of the vehicle 10 to the plurality of drones 30.

The server 20 may receive, from each drone 30 included in the plurality of drones 30, a response as to whether the location information is received. The response as to whether the location information is received may include information related to a current state of each drone 30. Information related to a current state of a corresponding drone 30 may include at least one of the following: a current location of the corresponding drone 30, a type of a sensor provided in the corresponding drone 30, and a battery remaining capacity of the corresponding drone 30.

Using information included in the response as to whether the location information is received, the server 20 may select any one drone 30 from among the plurality of drones 30. The server 20 may transmit, to the selected drone 30, a message instructing movement to the vehicle 10.

Real-time information of the drone 30 moving toward the vehicle 10 may be provided to a user of the vehicle 10. Hereinafter, a detailed description will be provided with reference to FIG. 15.

FIG. 15 is a flowchart for explaining in a detail a step to request connection in a control method of an AVHS according to an embodiment of the present invention.

Referring to FIG. 15, the step S1330 to request connection by a drone according to an embodiment of the present invention may include a step S1331 to initiate movement using location information, a step S1332 to transmit drone location-related real time information, and a step S1333 to request connection.

In the step S1331, the drone 30 initiates movement using location information. Specifically, the drone 30 imitates movement to the vehicle 10 using location information of the vehicle 10, which is previously received from the server 20. According to an embodiment, when receiving a message instructing movement to the vehicle 10 from the server 20, the drone 30 may initiate the movement.

In the step S1332, the drone 30 may transmit real-time information to the server 20. Specifically, while moving toward the vehicle 10, the drone 30 may transmit real-time information related to a location of the drone 30 to the server 20.

According to an embodiment, the real-time information may include at least one of the following: a current location of the drone 30 and a time required for the drone 30 required to arrive at the vehicle 10.

According to an embodiment, the vehicle 10 may further include receiving the real-time information from the server 20. A user of the vehicle 10 is able to be in real time aware of a situation since arrival of the drone 30 before receiving driving assistance, and thus, the user's convenience may improve.

In the step S1333, the drone 30 approaching in proximity of the vehicle 10 transmits a connection request. Specifically, when a distance between the drone 30 and the vehicle 10 is equal to or smaller than a predetermined value, the drone 30 may transmit the connection request to the vehicle 10. The predetermined value may be set to a specific value in such a way not to transmit the connection request to another vehicle 10. According to an embodiment, the connection request may include at least one of ID of the drone 30 or an authentication key received from the server 20.

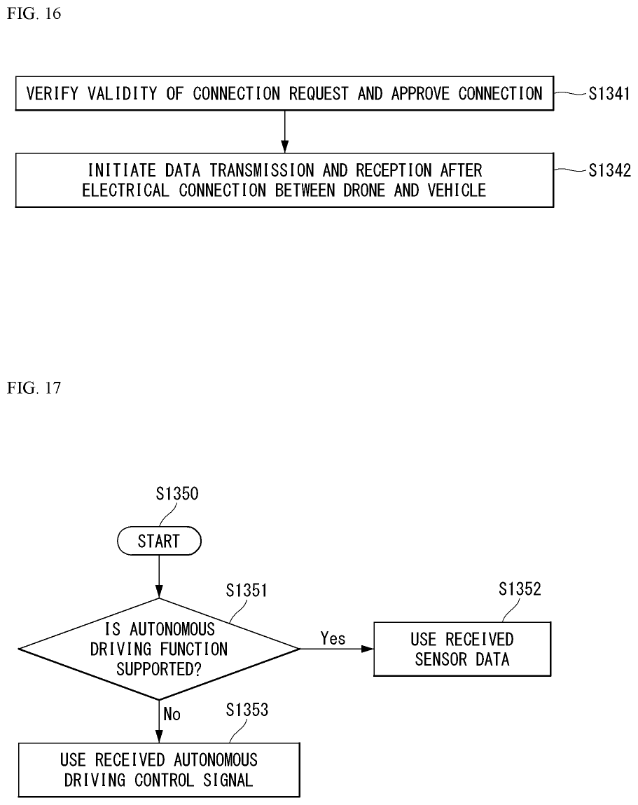

The drone 30 assists driving of the vehicle, and, when the vehicle 10 is a manually driven vehicle, an authority to control driving the vehicle 10 is substantially transferred to the drone 30. Therefore, security needs to be considered when it comes to connection between the vehicle 10 and the drone 30. Hereinafter, a detailed description will be provided with reference to FIG. 16.

FIG. 16 is a flowchart for explaining in a detail a step to initiate data transmission and reception for autonomous driving in a control method of an AVHS according to an embodiment of the present invention.

Referring to FIG. 16, the step S1340 to initiate data transmission and reception for autonomous driving may include a step S1341 to verify a connection request and approve connection, and a step S1342 to initiate data transmission and reception after electrical connection between the drone and the vehicle.

In the step S1341, the vehicle 10 verifies a connection request received from the drone 30. Specifically, after verifying validity of the connection request, the vehicle 10 may transmit connection approval to the drone 30.

According to an embodiment, the vehicle 10 may transmit the connection approval according to whether ID of the drone 30 or an authentication key included in the connection request matches information received from the server 20. For example, when at least one of the ID of the drone 30 or the authentication key included in the connection request does not match information received from the server 20, the vehicle 10 may not transmit the connection approval.

In the step S1342, when electrically connected to the drone 30, the vehicle 10 initiate data transmission and reception for autonomous driving. Specifically, when the drone 30 having received the connection approval moves to a preset location and is then electrically connected to the vehicle 10, the vehicle 10 may initiate the data transmission and reception.

According to an embodiment, the preset location may be a landing point provided at an exterior of the vehicle 10 or a location in a region formed at a predetermined distance from the vehicle 10. The preset distance may be set to a specific value in consideration of a data speed required to perform the autonomous driving, a degree of convenience to acquire e sensor data to assist the autonomous driving of the vehicle 10, and the like.

When the data transmission and reception is initiated, the vehicle 10 may transmit, to the drone 30, information on fuel of the vehicle 10, information on a remaining battery capacity of the vehicle 10, or any other real-time information of the vehicle 10 related to autonomous driving.

As such, whether to connect to the vehicle 10 is determined depending on whether the connection request from the drone 30 is valid. Therefore, it is possible to prevent the vehicle 10 from being connected to a drone 30 not related to a driving assistance request or from being exposed to a crime, such as robbery.

The vehicle 10 operates using driving assistance data received from the drone 30. Hereinafter, operation of the vehicle 100 according to an autonomous driving function of the vehicle 10 is supported will be described in detail with reference to FIG. 17.

FIG. 17 is a flowchart for explaining in detail a step to perform autonomous driving using driving assistance data in a control method of an AVHS according to an embodiment of the present invention.

Referring to FIG. 17, the vehicle 10 starts to perform autonomous driving using the driving assistance data (S1350).

In step S1351, when the vehicle 10 supports an autonomous driving function, the vehicle 10 operates using data received from the drone 30. Specifically, the vehicle 10 may generate an autonomous driving pass using at least one of the following: sensor data acquired through a sensor normally operating among a plurality of sensors provided in the vehicle, first sensor data acquired through a sensor of the drone 30, and second sensor data acquired through a sensor of the drone 30, which corresponds to a sensor in which an error is detected among the plurality of sensors,

In an object detection area outside the vehicle 10, an area sensed by the sensor in which the error is detected may be supplemented using at least one of the first sensor data or the second sensor data.

In step S1351, when the vehicle 10 is a manually driven vehicle not supporting an autonomous driving function, the vehicle 10 operates in accordance with the autonomous driving control signal. At this point, the vehicle 10 is not capable of performing autonomous driving on its own, and thus, an authority to control the autonomous driving is given to the drone 30 that generates the autonomous driving control signal. That is, the autonomous driving is performed as the vehicle 10 generates a control signal corresponding to the autonomous driving control signal and transits the control signal to each element of the vehicle 10.

As such, the present invention may supplement an object detection area of the vehicle 10, which has transmitted a driving assistance request, thereby reducing an accident possibility. In addition, although the vehicle 10 does not support an autonomous driving function, the present invention supports the vehicle 10 to perform autonomous driving in accordance with an autonomous driving control signal of the drone 30. Therefore, it is possible to provide convenience to a user who is difficult to drive by himself or herself.

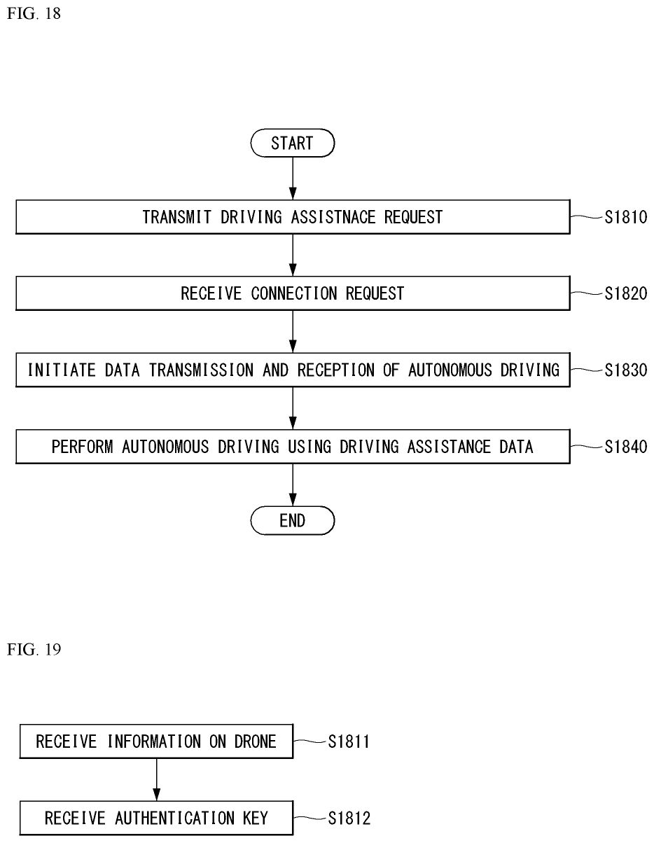

Hereinafter, FIGS. 18 to 21 will be described in terms of a method for controlling a vehicle operating in an AVHS according to an embodiment of the present invention.

FIG. 18 is a flowchart for explaining a method for controlling a vehicle operating in an AVHS according to an embodiment of the present invention.

Referring to FIG. 18, a method for controlling a vehicle operating in an AVHS according to an embodiment of the present invention may include a step S1810 to transmit a driving assistance request, a step S1820 to receive a connection request, a step S1830 to initiate data transmission and reception for autonomous driving, and a step S1840 to perform autonomous driving using driving assistance data.

In the step S1810, the vehicle 10 may transmit an assistance request to the server 20 in response to satisfaction of a preset condition or in response to an input of a user.

According to an embodiment, when an error in one of the plurality of sensors is detected, when an accident possibility is equal to or higher than a predetermined level, or when occurrence of an emergency is sensed, the vehicle 10 may transmit the autonomous driving request. The emergency may include a situation where the user is not capable of driving normally. For example, the emergency may include a case where the user dozes off and thereby close his/her eyes or bend his/her head

However, aspects of the present invention are not limited thereto, and the vehicle 10 may transmit the driving assistance request in any situation where an accident possibility increases. Even in a case where the user is not able to recognize a dangerous situation directly, the driving assistance request can be transmitted and therefore an accidence probability can be reduced.

According to an embodiment, the vehicle 10 may determine the accident possibility using at least one of the following: a monitoring result of the user, a signal according to at least one ADAS function related to autonomous driving, and vehicle state data related to a state of the vehicle 10.

According to an embodiment, the autonomous assistance request may include at least one of the following: a driving destination, a state of the user, information related to autonomous driving of the vehicle 10, a location of the vehicle 10, and identification information of the vehicle 10.

According to an embodiment, the state of the user may include at least one of the following: whether the user is drunk, whether the user is injured, whether the user is an elderly person, whether the user is pregnant, and any other information about health of the user.

The information related to autonomous driving of the vehicle 10 may include at least one of the following: whether the vehicle 10 is capable of traveling, whether the vehicle 10 is involved in an accident, information on a sensor in which the error is detected among the sensors of the vehicle 10, and whether the vehicle 10 supports an autonomous driving function.

The identification information of the vehicle 10 may include at least one of a color, a type, or a licensed number of the vehicle 10.

In step S1820, the vehicle 10 may receive a connection request from a drone 30 selected by the server 20 in response to the driving assistance request. Specifically, the server 20 having received the driving assistance request selects a drone 30 capable of assisting driving of the vehicle 10 and transmits location information of the vehicle 10 to the selected drone 30. The vehicle 10 may receive the connection request from the drone 30 which has received the location information.

In step S1830, the vehicle 10 authenticates the connection request and initiates data transmission and reception for autonomous driving. Specifically, the vehicle 10 may verify validity of the connection request and initiate transmission and reception for data for the autonomous driving. The connection request may include at least one of ID of the drone 30 or an authentication key. The authentication key may be generated by the server 20 to connect the vehicle 10 and the drone 30.

In step S1840, the vehicle 10 performs the autonomous driving using driving assistance data received from the drone 30. The driving assistance data may include at least one of the following: first sensor data acquired through a sensor of the drone 30, second sensor data acquired by a sensor of the drone 30 corresponding to a sensor in which an error is detected among the plurality of sensors included in the sensor unit, and an autonomous driving control signal instructing operation of the vehicle 10.

According to an embodiment, when the vehicle 10 supports an autonomous driving function, the vehicle 10 may perform the autonomous driving using at least one of sensor data acquired through a normally operating sensor or sensor data received from the drone 30. When the vehicle 10 does not support an autonomous driving function, the vehicle 10 may operate in accordance with the autonomous driving control signal.

According to an embodiment, the autonomous driving control signal may be a signal that indicates an operation of vehicular elements related to at least one of the following: turning on/off ignition, a driving speed, gear shift, an engine RPM, turning on/off a head light, turning on/off a turn signal, and lane change.

According to an embodiment, the method for controlling a vehicle may further include a step to request connection release.

In the step to request connection release, the vehicle 10 may transmit the connection release request to the server 20 to disconnect from the drone 30 when the vehicle 10 arrives at a destination according to the driving assistance request.

Hereinafter, FIGS. 19 to 21 will explain in more detail steps of an AVHS according to an embodiment of the present invention.

FIG. 19 is a flowchart for explaining in more detail a step to request driving assistance in a method for controlling a vehicle operating in an AVHS according to an embodiment of the present invention.

Referring to FIG. 19, the step to transmit driving assistance according to an embodiment of the present invention may further include a step S1811 to receive information on the drone 30 and a step S1812 to receive an authentication key.

In the step S1811, the vehicle 10 receives information on a drone 30 selected by the server 20. Specifically, the server 20 having received a driving assistance request from the vehicle 10 may select a drone 30 capable of assisting driving of the vehicle 10. According to an embodiment, the selected drone 30 may be a drone 30 that is selected by a preset standard from among a plurality of drones 30 pre-registered in the server 20. The preset standard may include at least one of the following: a degree of adjacency of each drone included in the plurality of drones to the vehicle 10, whether a sensor necessary for the vehicle 10 is provided, and a remaining battery capacity required to assist autonomous driving of the vehicle 10.

The information on the drone 30 may include ID or a type of the drone 30.

In the step S1812, the vehicle 10 receives an authentication key. The authentication key may be generated by the server 20 to connect the vehicle 10 having transmitted the driving assistance request and the selected drone 30. According to an embodiment, the authentication key may be valid only before a preset time expires since a generation timing of the authentication key.

A length of the preset valid period may be determined by a time required for the drone 30 to arrive at the vehicle 10. For example, when the selected drone 30 needs five minutes to arrive at the vehicle 10, the length of the preset valid period may be six minutes.

However, aspects of the present invention are not limited thereto, and the length of the preset valid period may be set to a different value by taking all into consideration a time required to connect the vehicle 10 and the drone 30, any other communication environment, a level of security set in the vehicle 10, and the like.

According to an embodiment, when the valid time of the authentication key expires, the server 20 may receive an authentication key update request from the vehicle 10. The vehicle 10 may receive an authentication key re-generated by the server 20.

According to another embodiment of the present invention, in a case where the valid time expires even though there is no authentication update request from the vehicle 10, the vehicle may receive a new authentication key from the server 20. The authentication key of which valid time expires may be set to be automatically discarded in the vehicle 10 or the drone 30, or, when the new authentication key is received, a previous authentication key may be set to be discarded.

It is described that the step S1812 follows the step S1811, but this is merely an example for convenience of explanation, and the principal of the present invention is not limited to the corresponding order. The above-described steps S1811 and S1822 may be performed in a different order or may be performed at the same time in parallel after the step S1810.

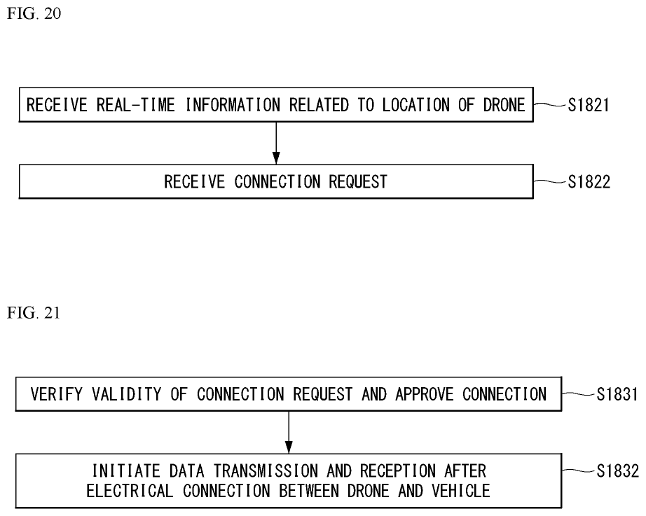

Real-information of the drone 30 moving to the vehicle 10 may be provided to a user of the vehicle 10. A detailed description will be provided with reference to FIG. 20.

FIG. 20 is a flowchart for explaining in detail a step to receive a connection request in a method for controlling a vehicle operating in an AVHS according to an embodiment of the present invention.

Referring to FIG. 20, the step S1820 to receive a connection request according to an embodiment of the present invention may include a step S1821 to receive real-time information related to a location of a drone and a step S1822 to receive a connection request.

In the step S1821, the vehicle 10 receives real-time information related to a location of the drone 30 from the server 20. The real-time information may include at least one of the following: a current location of the drone 30, a moving path of the drone 30, and a time required for the drone 30 to arrive at the vehicle 10. The real-time information may be information received from the server 20 or received from the drone 30. According to an embodiment, the vehicle 10 may provide the real-time information to a user.

In the step S1822, when a distance between the drone 30 and the vehicle 10 is equal to or smaller than a predetermined value, the vehicle 10 may receive a connection request from the drone 30. The predetermined value may be set to a specific value in consideration of a communication protocol, specification of the vehicle 10 or the drone 30, and the like.

As such, the present invention may provide the real-time information to a user. The user is able to be in real time aware of a situation since arrival of the drone 30 before receiving driving assistance, and thus, the user's convenience may improve.

In addition, as the present invention receives a connection request from the drone 30 from which a distance to the vehicle 10 is equal to or smaller than the predetermined value, it is possible to prevent the vehicle 10 from being connected to a drone 30 not related to a driving assistance request.

The drone 30 assists driving of the vehicle, and, when the vehicle 10 is a manually driven vehicle, an authority to control driving the vehicle 10 is substantially transferred to the drone 30. Therefore, security needs to be considered when it comes to connection between the vehicle 10 and the drone 30. Hereinafter, a detailed description will be provided with reference to FIG. 21.

FIG. 21 is a flowchart for explaining in detail a step to initiate data transmission and reception for autonomous driving in a method for controlling a vehicle operating in an AVHS according to an embodiment of the present invention.

Referring to FIG. 21, the step S1830 to initiate data transmission and reception according to an embodiment of the present invention may include a step S1831 to verify validity of a connection request and approve connection and a step S1832 to initiate data transmission and reception after electrical connection between a drone and a vehicle.

In the step S1831, the vehicle 10 verifies a connection request received from the drone 30. Specifically, the vehicle 10 may verify validity of the connection request and transmits connection approval to the drone 30.

According to an embodiment, the vehicle 10 may transmit the connection approval depending on whether ID of the drone 30 or an authentication key included in the connection request matches information received from the server 20. For example, when at least one of the ID of the drone 30 or the authentication key included in the connection request does not match information received from the server 20, the vehicle 10 may not transmit the connection approval.

In the step S1832, when the vehicle 10 is electrically connected to the drone 30, the vehicle 10 initiates data transmission and reception for autonomous driving. Specifically, when the drone 30 having received the connection approval moves to a preset location and is then electrically connected to the vehicle 10, the vehicle 10 may initiate the data transmission and reception.

According to an embodiment, the preset location may be a landing point provided at an exterior of the vehicle 10 or a location in a region formed at a predetermined distance from the vehicle 10. The preset distance may be set to a specific value in consideration of a data speed required to perform the autonomous driving, a degree of convenience to acquire e sensor data to assist the autonomous driving of the vehicle 10, and the like.

When the data transmission and reception is initiated, the vehicle 10 may transmit, to the drone 30, information on fuel of the vehicle 10, information on a remaining battery capacity of the vehicle 10, or any other real-time information of the vehicle 10 related to autonomous driving.

As such, whether to connect to the vehicle 10 is determined depending on whether the connection request from the drone 30 is valid. Therefore, it is possible to prevent the vehicle 10 from being connected to a drone 30 not related to a driving assistance request or from being exposed to a crime, such as robbery.

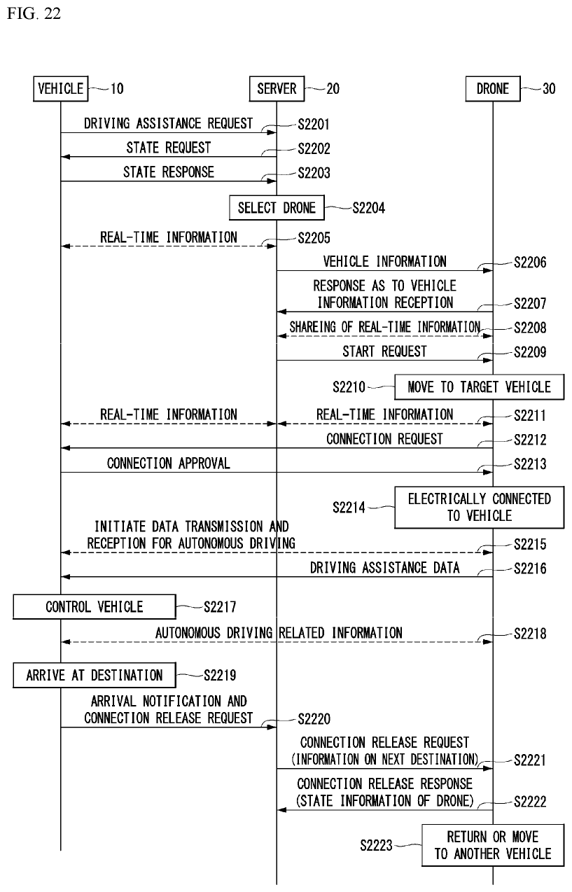

Hereinafter, FIG. 22 explains primarily a data flow between elements in an AVHS according to an embodiment of the present invention.

FIG. 22 is a diagram for explaining in detail a data flow between elements in an AVHS according to an embodiment of the present invention.

Referring to FIG. 22, the vehicle 10 transmits a driving assistance request to the server 20 (S2201).

The driving assistance request may include a driving destination, a state of a user, information related to autonomous driving of the vehicle 10, a location of the vehicle 10, or identification information of the vehicle 10.

According to an embodiment, information include in the driving assistance request may be separately transmitted in response to a state request from the server 20. Specifically, the server 20 having received the driving assistance request may transmit a state request to the vehicle 10 (S2202). The vehicle 10 may respond to the request from the server 20 by transmitting a state response (S2203).

The server 20 selects a drone 30 capable of assisting driving of the vehicle 10 having transmitted the driving assistance request (S2204). According to an embodiment, the server 20 may select any one drone 30 from among a plurality of pre-registered drones 30 by a preset condition.

A connection session between the server 20 and the vehicle 10 may not be terminated so that real-time information is shared between the server 20 and the vehicle 10 (S2205). Through the connection session, the vehicle 10 may receive information on the selected drone 30 and an authentication key from the server 20.

The server 20 transmits information on the vehicle 10 to the selected drone 30 (S2206). Having received the information on the vehicle 10, the drone 30 may respond to the server 20 by transmitting a response as to the reception of the vehicle information (S2207). The connection session between the server 20 and the drone 30 may not be terminated so that the real-time information is shared. According to an embodiment, the server 20 may transmit a start request to the drone 30 to thereby instruct the drone 30 to move to the vehicle 10 (S2209). Having received the start request, the drone 30 initiates movement toward the vehicle 10 using the pre-received vehicle information (S2210). According to another embodiment, the drone 30 may initiate movement toward the vehicle 10 immediately upon reception of the vehicle information.

A connection session between the vehicle 10 and the server 20 and a connection session between the server 20 and the drone 30 may be maintained, not terminated (S2211). According to an embodiment, the drone 30 may transmit real-time information related to a location of the drone 30 to the server 20 through the connection session. The server 20 may forward the real-time information related to the location of the drone 30 to the vehicle 10. The vehicle 10 may provide the real-time information to the user.

The vehicle 10 receives a connection request from the drone 30 (S2212). According to an embodiment, the vehicle 10 may receive the connection request from the drone 30 from which a distance to the vehicle 10 is equal to or smaller than a predetermined value. The connection request may include at least one of ID of the drone 30 or an authentication key.

The vehicle 10 may verify validity of the connection request and transmit connection approval to the drone 30 (S2213). The vehicle 10 may determine the validity of the connection request according to whether ID of the drone 30 or an authentication key included in the connection request matches information received from the server 20.

Having received the connection approval, the drone 30 approaches the vehicle 10 and is then electrically connected to the vehicle 10 (S2214). According to an embodiment, the drone 30 may be electrically connected to the vehicle 10 by landing at a landing point provided in the vehicle 10. The landing point may include a contact point enabling the electrical connection between the vehicle 10 and the drone 30, and may include a fastening part for fixing the drone 30 to the vehicle 10.

According to an embodiment, the drone 30 may be connected to the vehicle 10 by a non-contact method. Specifically, the drone 30 may be connected to the vehicle 10 while hovering over a region formed at a preset distance from the vehicle 10.

When the vehicle 10 and the drone 30 are electrically connected, data transmission and reception for autonomous driving of the vehicle 10 is initiated (S2215).

The vehicle 10 receives driving assistance data from the drone 30 (S2216). The driving assistance data may include at least one of the following: first sensor data acquired through a sensor of the drone 30, second sensor data acquired by a sensor of the drone 30 corresponding to a sensor in which an error is detected among the plurality of sensors included in the sensor unit, and an autonomous driving control signal indicating an operation of the vehicle 10.

The vehicle 10 may control each element of the vehicle 10 using data received from the drone 30 (S2217).

Specifically, when the vehicle 10 supports an autonomous driving function, the vehicle 10 operates using data received from the drone 30. Specifically, the vehicle 10 may generate an autonomous driving pass using at least one of the following: sensor data acquired through a sensor normally operating among a plurality of sensors provided in the vehicle, first sensor data acquired through a sensor of the drone 30, and second sensor data acquired through a sensor of the drone 30 corresponding to a sensor in which an error is detected among the plurality of sensors.

When the vehicle 10 is a manually driven vehicle not supporting an autonomous driving function, the vehicle 10 operates in accordance with the autonomous driving control signal. At this point, the vehicle 10 is not capable of performing autonomous driving on its own, and thus, an authority to control the autonomous driving is given to the drone 30 that generates the autonomous driving control signal. That is, the autonomous driving is performed as the vehicle 10 generates a control signal corresponding to the autonomous driving control signal and transits the control signal to each element of the vehicle 10.

The vehicle 10 transmits and receives autonomous driving related information (S2218). The autonomous driving related information may include state data of vehicle 10.

According to an embodiment, the state data may include at least one data of vehicle attitude data, vehicle motion data, vehicle yaw data, vehicle roll data, vehicle pitch data, vehicle collision data, vehicle direction data, vehicle angle data, vehicle speed data, vehicle acceleration data, vehicle tilt data, vehicle forward/backward driving data, vehicle weight data, battery data, fuel data, tire pressure data, in-vehicle temperature data, in-vehicle humidity data, steering wheel rotation angle data, vehicle ambient illumination data, data on pressure applied to an acceleration pedal, or data on pressure applied to a brake pedal.

When the vehicle 10 arrives at a destination according to the driving assistance request in the step S2219, the vehicle 10 transmits a connection release request to the server 20 (S2220).

Having received the connection release request from the vehicle 10, the server 20 may transmit a connection release request to the drone 30 (S2221). The connection release request may include information of a next destination (a current location of another vehicle 10).

The drone 30 may transmit a connection release response to the server 20 (S2222). The connection release response may include information related to a state of the drone 30.

The drone 30 may return back to an original location or keep performing driving assistance by moving to the another vehicle 10 (S2223).

In regard with the steps S2221 to S2223, according to another embodiment, the server 20 may transmit a state information request for connection release from the vehicle 10 to the drone 30. The drone 30 may transmit state information for the connection release to the server 20.

The state information for the connection release may include at least one of the following: a current location of the vehicle 10, a surrounding image of the vehicle 10, a current location of the drone 30, a remaining battery capacity of the drone 30, and any other state information related to a driving assistance operation of the drone 30.

The server 20 may transmit, to the drone 30, a connection release response according to whether security of the vehicle 10 is secured, which is determined through the state information.

When the server 20 determines that safety of the vehicle 10 is ensured, the drone 30 may disconnect the connection with the vehicle 10 according to the connection release response and then may move to a close charging station to charge, may move to another vehicle 10 assist driving of the another vehicle 10, or may return back to an original location.

When the server 20 determines that safety of the vehicle 10 is not ensured, the drone 30 may generate an autonomous driving control signal while maintaining the connection according to the connection release response and transmit the autonomous driving control signal to the vehicle 10. The autonomous driving control signal controls the vehicle 10 to move to a specific location. When the vehicle 10 moves to the specific location, the drone 30 may transmit the state information to the server 20 again.

The server 20 may use the state information to determine as to whether safety of the vehicle 10 is ensured, and may transmit, to the drone 30, a connection release response that instructs the drone 30 to disconnect the connection or generate an autonomous driving control signal again.

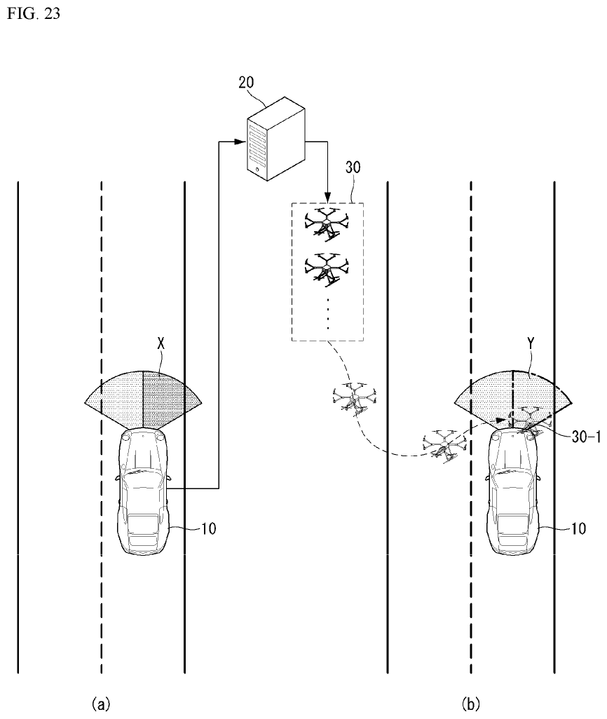

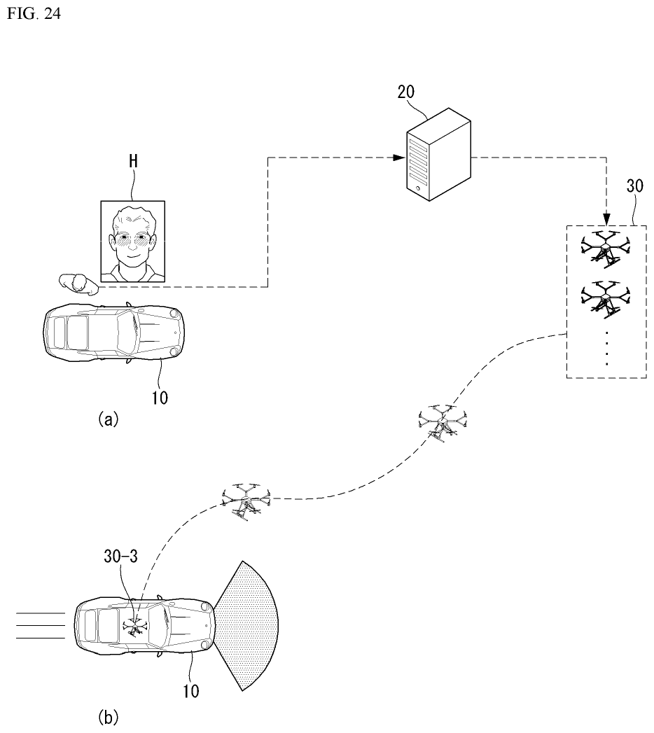

Driving assistance according to the present invention can be utilized when a problem occurs in the vehicle 10 or when a user is not capable of driving the vehicle 10, and a detailed description thereof will be hereinafter provided with reference to FIGS. 23 and 24.

FIG. 23 is a diagram for explaining an example to which the present invention is applied when it comes to a driving assistance request. It is assumed that an error occurs in some of sensors in the vehicle 10 and that the vehicle 10 supports an automatically driving function.

Referring to part (a) of FIG. 23, a region X in an object detection area located outside the vehicle 10 may detect an object normally. As an error is detected in at least one sensor, the vehicle 10 transmits a driving assistance request to the server 20. At this point, the driving assistance request may include a type of the sensor in which the error is detected among the sensors in the vehicle, and a current location of the vehicle 10.

Having received the driving assistance request, the server 20 may select a drone 30-1 having a sensor capable of assisting driving of the vehicle 10 from among a plurality of drones 30 pre-registered in the server 20. The selected drone 30-1 may be a drone 30 having a sensor corresponding to the sensor in which the error is detected among the sensors in the vehicle 10.

The server 20 transmits information on the selected drone 30 to the vehicle 10 and generates an authentication key for connection between the vehicle 30-1 and the drone 30. The server 20 transmits the authentication key to the vehicle 10 and the server 20. The selected drone 30-1 moves to the vehicle 10 by receiving information on the vehicle 10 from the server 20.

Referring to part (b) of FIG. 23, the drone 30-1 having approached the vehicle 10 transmits a connection request. The vehicle 10 may transmit connection approval by determining whether ID or authentication key of the drone 30-1 included in the connection request matches information received from the server 20.

Having received the connection approval, the drone 30-1 is electrically connected to the vehicle 10. When a landing point is not provided in the vehicle 10, the drone 30-1 is electrically connected to the vehicle 10 in a hovering state. The drone 30-1 is electrically connected to the vehicle 10 at a location corresponding to a location of a sensor in which an error is detected among sensors of the vehicle 10.

In a region Yin an object detection target area, where object detection was not allowed due to the sensor in which the error is detected, object detection becomes allowed through second sensor data transmitted by the drone 30 to the vehicle 10. Accordingly, the vehicle 10 may generate an autonomous driving pass and thereby perform autonomous driving.

As such, when the vehicle 10 is not capable of performing autonomous driving normally because a problem occurs in a sensor, the vehicle 10 may receive driving assistance quickly through the drone 30 having a sensor corresponding to the sensor in which the problem occurs.

FIG. 24 is a diagram for explaining another example to which the present invention is applied when it comes to a driving assistance request. It is assumed that the vehicle 10 is a manually driven vehicle not supporting an autonomous driving function, that a user H is allowed to drive due to drinking, and that a lading point for the drone 30 is provided at a roof of the vehicle 10.

Referring to part (a) of FIG. 24, the user H may transmit a driving assistance request to the server 20 by himself or herself. The driving assistance may include a state of the user (a drunk state), a current location of the vehicle, and information whether the vehicle 10 supports an autonomous driving function.

Having received the driving assistance request, the server 20 may select a drone 30-3 capable of assisting driving of the vehicle 10 from among a plurality of pre-registered drones 30.

The selected drone 30-3 may be a drone 30 having a sensor for autonomous driving of the vehicle 10 and capable of generating an autonomous driving control signal to instruct the vehicle 10 to move in accordance with an autonomous driving pass generated by the drone 30.

The drone 30-3 receives location information of the vehicle 10 from the server 20 and then approaches the vehicle 10. The location information of the vehicle 10 may include a location (roof) of the landing point provided in the vehicle 10.

Referring to part (b) of FIG. 24, the drone 30-3 approaches the vehicle 10 and transmits a connection request. Having received connection approval from the vehicle 10, the drone 30-3 moves to a landing point provided in the vehicle 10 and is then electrically connected to the vehicle 10.

The drone 30-3 may detect an object located outside the vehicle 10 to perform autonomous driving of the vehicle 10. According to detection of the object, the drone 30-3 generates an autonomous driving signal to control an operation of the vehicle 10, and transmits the autonomous driving signal to the vehicle 10.

The vehicle 10 generates a signal corresponding to the autonomous driving control signal and transmits the generated signal to each element of the vehicle 10. The vehicle 10 transmits a result of a control operation dependent on the autonomous driving control signal to the drone 30-3. The result of the control operation may include information related to a current state of the vehicle 10.

As such, the present invention may support autonomous driving of the vehicle 10 even when the vehicle 10 does not support an autonomous driving function, and may assist driving when a user is not allowed to drive by himself or herself, thereby reducing an accident possibility.

The present invention may include embodiments as follows.

### Embodiment 1

A method of controlling a vehicle operating in an Automated Vehicle and Highway System (AVHS), the method including: transmitting a driving assistance request to a server in response to satisfaction of a preset condition or in response to an input of a user; in response to the driving assistance request, receiving a connection request from a drone selected by the server; initiating data transmission and reception for autonomous driving by authenticating the connection request; and performing the autonomous driving using driving assistance data received from the drone, wherein the driving assistance data comprises at least one of the following: first sensor data acquired through a sensor of the drone, second sensor data acquired through a sensor of a drone, the sensor corresponding to a sensor in which an error is detected among sensors of the vehicle, and an autonomous driving control signal indicating an operation of the vehicle.

### Embodiment 2

Regarding Embodiment 1, in the transmitting of the driving assistance request, the vehicle may transmit the driving assistance request when an error is detected in at least one sensor, when an accident possibility is equal to or higher than a predetermined level, or when occurrence of an emergency is sensed.

### Embodiment 3

Regarding Embodiment 2, the driving assistance request may include at least one of the following: a driving destination, a state of the user, information related to the autonomous driving of the vehicle, a location of the vehicle, and identification information of the vehicle.

### Embodiment 4

Regarding Embodiment 3, the state of the user may include at least one of the following: whether the user is drunk, whether the user is elderly, whether the user is pregnant, and any other information related to health of the user, the information related to the autonomous driving of the vehicle may include at least one of the following: whether the vehicle is allowed to travel, whether an accident of the vehicle happens, information on a sensor in which the error is detected among sensors of the vehicle, and whether the vehicle supports an autonomous driving function, and the identification information of the vehicle may include at least one of a color, a type, or a licensed number of the vehicle.

### Embodiment 5

Regarding Embodiment 1, the transmitting of the driving assistance request further may include: receiving information on the drone selected by the server; and receiving an authentication key that is generated by the server to connect the drone and the vehicle.

### Embodiment 6

Regarding Embodiment 5, the authentication key may be valid only before a preset valid time expires since a generation timing of the authentication key.

### Embodiment 7

Regarding Embodiment 6, when a valid time of the authentication key expires, the vehicle may request update of the authentication key from the server and receives a re-generated authentication key from the server

### Embodiment 8

Regarding Embodiment 1, the receiving of the connection request may include: receiving real-time information related to a location of the drone from the server; and, when a distance between the drone and the vehicle is equal to or smaller than a predetermined value, receiving the connection request from the drone.

### Embodiment 9

Regarding Embodiment 8, the real-time information may include at least one of the following: a current location of the drone, a moving path of the drone, and a time required for the drone to arrive at the vehicle.

### Embodiment 10

Regarding Embodiment 1, the initiating of the data transmission and reception may include: verifying validity of the connection request and transmitting connection approval to the drone; and, when the drone moves to a preset location in response to reception of the connection approval and is then electrically connected to the vehicle, initiating the data transmission and reception with the drone.

### Embodiment 11

Regarding Embodiment 10, the preset location may be a landing point provided in an exterior of the vehicle or a location in a region formed at a preset distance from the vehicle.

### Embodiment 12

Regarding Embodiment 10, when the data transmission and the reception is initiated, the vehicle may transmit, to the drone, at least one of the following: fuel of the vehicle, a remaining battery capacity of the vehicle, and real-time information of the vehicle related to the autonomous driving.

### Embodiment 13

Regarding Embodiment 11, in the performing of the autonomous driving using the driving assistance data, when the vehicle does not support an autonomous driving function, the vehicle may perform the autonomous driving using at least one of sensor data acquired through a normally operating sensor or sensor data received from the drone, or, when the vehicle does not support the autonomous driving function, the vehicle may operate in accordance with the autonomous driving control signal.

### Embodiment 14

Regarding Embodiment 13, the autonomous driving control signal may indicate an operation of vehicular elements related to at least one of the following: turning on/off ignition, a driving speed, gear shift, an engine RPM, turning on/off a head light, turning on/off a turn signal, and lane change.

### Embodiment 15

A control method of an Automated Vehicle and Highway System (AVHS), the method including: transmitting, by a vehicle, a driving assistance request to a server in response to satisfaction of a preset condition or in response to an input of a user; transmitting, by the server, location information of the vehicle to a drone having a sensor for assisting autonomous driving of the vehicle; approaching the vehicle and transmitting a connection request by the drone; initiating, by the vehicle, data transmission and reception for autonomous driving by authenticating the connection request; and performing, by the vehicle, the autonomous driving using driving assistance data received from the drone, wherein the driving assistance data comprises at least one of the following: first sensor data acquired through a sensor of the drone, second sensor data acquired through a sensor of a drone, the sensor corresponding to a sensor in which an error is detected among sensors of the vehicle, and an autonomous driving control signal indicating an operation of the vehicle.

### Embodiment 16

Regarding Embodiment 15, in the transmitting of the driving assistance request, the vehicle may transmit the driving assistance request when an error is detected in at least one sensor, when an accident possibility is equal to or higher than a predetermined level, or when occurrence of an emergency is sensed.

### Embodiment 17

Regarding Embodiment 16, the driving assistance request may include at least one of the following: a driving destination, a state of the user, information related to the autonomous driving of the vehicle, a location of the vehicle, and identification information of the vehicle.

### Embodiment 18

Regarding Embodiment 17, the state of the user may include at least one of the following: whether the user is drunk, whether the user is elderly, whether the user is pregnant, and any other information related to health of the user, the information related to the autonomous driving of the vehicle may include at least one of the following: whether the vehicle is allowed to travel, whether an accident of the vehicle happens, information on a sensor in which the error is detected among sensors of the vehicle, and whether the vehicle supports an autonomous driving function, and the identification information of the vehicle may include at least one of a color, a type, or a licensed number of the vehicle.

### Embodiment 19

Regarding Embodiment 15, the transmitting of the location information of the vehicle may include: selecting, by the server, any one drone from among a plurality of drones registered in the server by a preset standard; transmitting, by the server, information on the selected drone to the vehicle; and transmitting, by the server, the location information of the vehicle to the selected drone.

### Embodiment 20

Regarding Embodiment 19, the selecting of any one drone by the preset standard may include selecting, by the server, any one drone from among the plurality of drones by considering at least one of the following: a degree of adjacency to the vehicle, whether a sensor necessary for the vehicle is provided, and a remaining battery capacity required to assist the autonomous driving of the vehicle.

### Embodiment 21

Regarding Embodiment 19, the transmitting of the information on the drone to the vehicle may include generating an authentication key and transmitting the authentication key to the vehicle and the selected drone by the server, and the connection request may include at least one of ID of the selected drone or the authentication key.

### Embodiment 22

Regarding Embodiment 21, the authentication key may be valid only before a preset valid time expires since a generation timing of the authentication key.

### Embodiment 23

Regarding Embodiment 22, a length of the preset valid time may be determined by a time required for the selected drone to arrive at the vehicle.

### Embodiment 24

Regarding Embodiment 23, when a valid time of the authentication key expires, the vehicle may request update of the authentication key from the server, and the server may re-generate the authentication key and transmit the re-generated authentication key to the vehicle and the drone.

### Embodiment 25

Regarding Embodiment 15, the transmitting of the connection request may include: initiating, by the drone, movement using the location information; transmitting, by the drone which is moving, real-time information related to a location of the drone to the server; and, when a distance between the drone and the vehicle is equal to or smaller than a predetermined value, transmitting the connection request to the vehicle.

### Embodiment 26

Regarding Embodiment 25, the real-time information may include at least one of the following: a current location of the drone, a moving path of the drone, and a time required for the drone to arrive at the vehicle, and the transmitting of the real-time information may further include receiving, by the vehicle, the real-time information from the server.

### Embodiment 27

Regarding Embodiment 15, the initiating of the data transmission and reception for the autonomous driving may include: verifying validity of the connection request and transmitting connection approval to the drone by the vehicle; and, when the drone moves to a preset location in response to reception of the connection approval and is then electrically connected to the vehicle, initiating the data transmission and reception with the drone by the vehicle.

### Embodiment 28

Regarding Embodiment 27, the preset location may be a landing point provided in an exterior of the vehicle or a location in a region formed at a preset distance from the vehicle

### Embodiment 29

Regarding Embodiment 28, when the data transmission and the reception is initiated, the vehicle may transmit, to the drone, at least one of the following: fuel of the vehicle, a remaining battery capacity of the vehicle, and real-time information of the vehicle related to the autonomous driving.

### Embodiment 30

Regarding Embodiment 27, the performing of the autonomous driving using the driving assistance data may include: when the vehicle does not support an autonomous driving function, performing, by the vehicle, the autonomous driving using at least one of the following: sensor data acquired through a normally operating sensor, the first sensor data, and the second sensor data, and, when the vehicle does not support the autonomous driving function, operating, by the vehicle, in accordance with the autonomous driving control signal.

### Embodiment 31

Regarding Embodiment 15, the method may further include:
transmitting, by the vehicle, a connection release request to the server after arriving at a destination according to the driving assistance request; transmitting, by the server, a state information request for connection release to the drone; and transmitting, by the server, a connection release response to the drone.

### Embodiment 32

Regarding Embodiment 31, the state information for the connection release may include at least one of the following: a current location of the vehicle, a surrounding image of the vehicle, a current location of the drone, a remaining battery capacity of the drone, and state information related to a driving assistance operation of the drone.

### Embodiment 33

Regarding Embodiment 32, in the transmitting of the connection release response, the connection release response may include information that instructs a specific operation for the drone, and the server may use the state information to determine as to whether safety of the vehicle is ensured, and transmits the connection release response according to determination as to whether the safety of the vehicle is ensured

### Embodiment 34

Regarding Embodiment 33, the release response according to the determination as to whether the safety of the vehicle is ensured may include: when the safety of the vehicle is ensured, information that instructs release of connection to the vehicle; and when the safety of the vehicle is not ensured, information that instructs generation of the autonomous driving control signal to control the vehicle to move to a specific location, and the specific location may be a location at which no object is detected for a predetermined time in a specific area formed around the vehicle or a parking area closest to a current location of the vehicle.

### Embodiment 35

Regarding Embodiment 34, when the connection release response comprises the information instructing the release of the connection, the connection release response may include information instructing at least one of the following operations according to a state of the drone: 1) transmitting location information of another vehicle and assisting driving of the another vehicle; 2) moving to a charging station close to the current location of the drone and charging the drone; 3) returning back to an original location of the drone.

Embodiment 36: a vehicle operating in an Automated Vehicle and Highway System (AVHS) including a server and at least one drone which operate in conjunction for autonomous driving of the vehicle, the vehicle including: an interface unit configured to receive an input of a user, monitor a state of the user, and provide information generated by the vehicle to the user; a sensor unit having a plurality of sensors for detecting an object located outside the vehicle; a communication unit configured to transmit and receive an autonomous driving-related signal to an outside of the vehicle; and a controller configured to control driving related to the autonomous driving of the vehicle in conjunction with the server and the drone, wherein the controller is configured to transmit a driving assistance request to the server in response to satisfaction of a preset condition or in response to an input of a user; receive a connection request from a drone selected by the server in response to the driving assistance request, initiate data transmission and reception for autonomous driving by authenticating the connection request, and perform the autonomous driving using driving assistance data received from the drone, wherein the driving assistance data comprises at least one of the following: first sensor data acquired through a sensor of the drone, second sensor data acquired through a sensor of a drone, the sensor corresponding to a sensor in which an error is detected among sensors of the vehicle, and an autonomous driving control signal indicating an operation of the vehicle.

### Embodiment 37

Regarding Embodiment 36, the controller may be configured to transmit the driving assistance request when an error is detected in at least one sensor among the plurality of sensors, when an accident possibility is equal to or higher than a predetermined level, or when occurrence of an emergency is sensed.

### Embodiment 38

Regarding Embodiment 37, the driving assistance request may include at least one of the following: a driving destination, a state of the user, information related to the autonomous driving of the vehicle, a location of the vehicle, and identification information of the vehicle.

### Embodiment 39

Regarding Embodiment 38, the state of the user may include at least one of the following: whether the user is drunk, whether the user is elderly, whether the user is pregnant, and any other information related to health of the user, the information related to the autonomous driving of the vehicle may include at least one of the following: whether the vehicle is allowed to travel, whether an accident of the vehicle happens, information on a sensor in which the error is detected among sensors of the vehicle, and whether the vehicle supports an autonomous driving function, and the identification information of the vehicle may include at least one of a color, a type, or a licensed number of the vehicle.

### Embodiment 40

Regarding Embodiment 36, the controller may be configured to perform control so as to receive information on the drone selected by the server and receive an authentication key that is generated by the server to connect the drone and the vehicle.

### Embodiment 41

Regarding Embodiment 40, the authentication key may be valid only before a preset valid time expires since a generation timing of the authentication key.

### Embodiment 42

Regarding Embodiment 41, when a valid time of the authentication key expires, the controller may be configured to perform control so as to request authentication key update from the server and receive a re-generated authentication key from the server

### Embodiment 43

Regarding Embodiment 36, the controller may be configured to:

receive real-time information related to a location of the drone from the server; and when a distance between the drone and the vehicle is equal to or smaller than a predetermined value, receive the connection request from the drone.

### Embodiment 44

Regarding Embodiment 43, the real-time information may include at least one of the following: a current location of the drone, a moving path of the drone, and a time required for the drone to arrive at the vehicle, and the controller may be configured to perform control so that the real-time information is output through the user interface unit.

### Embodiment 45

Regarding Embodiment 36, the controller may be configured to: verify validity of the connection request and transmitting connection approval to the drone; and, when the drone moves to a preset location in response to reception of the connection approval and is then electrically connected to the vehicle, initiate the data transmission and reception with the drone.

### Embodiment 46

Regarding Embodiment 45, the preset location may be a landing point provided in an exterior of the vehicle or a location in a region formed at a preset distance from the vehicle.

### Embodiment 47

Regarding Embodiment 45, the controller may be configured to, when the data transmission and the reception is initiated, transmit, to the drone, at least one of the following: fuel of the vehicle, a remaining battery capacity of the vehicle, and real-time information of the vehicle related to the autonomous driving.

### Embodiment 48

Regarding Embodiment 45, the controller may be configured to control driving of the vehicle using sensor data acquired through a sensor normally operating among the plurality of sensors or sensor data received from the drone or to control the driving of the vehicle in accordance with the autonomous driving control signal.

### Embodiment 49

Regarding Embodiment 48, the autonomous driving control signal may indicate an operation of vehicular elements related to at least one of the following: turning on/off ignition, a driving speed, gear shift, an engine RPM, turning on/off a head light, turning on/off a turn signal, and lane change.

An AVHS and a vehicle included in the same according to an embodiment of the present invention include effects as follows.

In the present invention, a server having received a driving assistance request from a vehicle may transmit vehicle location information to a drone, and the drone may assist a role of a sensor provided in the vehicle or perform autonomous driving control. Therefore, the present invention may support a vehicle having a problem in performing autonomous driving or a manually driven vehicle in capable of driving autonomously to perform autonomous driving normally.

In addition, as the prevent invention assists driving of the vehicle using the drone, the vehicle having transmitted a driving assistance request may quickly receive driving assistance. Therefore, the present invention may reduce a time for the vehicle to wait until receiving the driving assistance.

In addition, in the present invention, a driving assistance request is transmitted when an error occurs in a sensor provided in the vehicle or when an emergency where a driver is not allowed to drive is sensed. Even when a user does not recognize a possibility of danger, a driving assistance request is transmitted, and thus, the present invention may reduce an accident possibility for the vehicle.

In addition, in the present invention, the vehicle uses an authentication key generated by the server to verify a connection request from a drone having approached the vehicle to support driving, and the authentication key is valid only for a predetermined time. Therefore, the present invention may prevent that the vehicle is connected to a drone irrelevant to driving assistance of the vehicle and thereby malfunctions or that the vehicle is robbed.

In addition, in the present invention, while the drone moves toward the vehicle to assist driving, the server transmits real-time information related to a location of the drone. As the present invention provides a time required to provide driving assistance to the vehicle, a current location of the drone, and the like, user convenience may improve.

In addition, in the present invention, even after the vehicle subject to driving assistance arrives at a destination, the drone does not release connection immediately and instead may release connection when safety of the vehicle is confirmed. Therefore, the present invention may reduce an accident possibility for the vehicle subject to driving assistance.

Meanwhile, the above-described present invention may be implemented in a medium in which a program is recorded, as a code that can be read by a computer. Example of the medium that can be read by a computer include an HDD (hard disk drive), an SSD (solid state disk), an SDD (silicon disk drive), a ROM, a RAM, a CD-ROM, a magnetic tape, a floppy disk, and an optical data storage unit. Also, another example of the recording medium may be implemented in a type of carrier wave (for example, transmission through the Internet). Thus, the above detailed description is to be considered in all respects as illustrative and not restrictive. The scope of the present invention should be determined by reasonable interpretation of the appended claims and all changes which come within the equivalent scope of the invention are included in the scope of the invention.

Further, although the embodiments have been described in the above, they are just exemplary and do not limit the present invention. Thus, those skilled in the art to the present invention pertains will know that various modifications and applications which have been exemplified may be performed within a range which does not deviate from the essential characteristics of the embodiments. For instance, the constituent elements described in detail in the exemplary embodiments can be modified to be performed. Further, the differences related to such modifications and applications shall be construed to be included in the scope of the present invention specified in the attached claims.

What is claimed is:

1. A method of controlling a vehicle operating in an Automated Vehicle and Highway System (AVHS), the method comprising:
transmitting a driving assistance request to a server satisfying a preset condition or according to an input of a user;
receiving a connection request from a drone selected by the server according to the driving assistance request;
initiating data transmission and reception for autonomous driving by authenticating the connection request; and
performing the autonomous driving using driving assistance data received from the drone,
wherein the driving assistance data comprises at least one of first sensor data acquired through a sensor of the drone, second sensor data acquired through a sensor of a drone, the sensor corresponding to a sensor in which an error is detected among sensors of the vehicle, or an autonomous driving control signal indicating an operation of the vehicle.

2. The method of claim 1, wherein, in the transmitting of the driving assistance request, the vehicle transmits the driving assistance request when an error is detected in at least one sensor, when an accident possibility is equal to or higher than a predetermined level, or when occurrence of an emergency is sensed.

3. The method of claim 2, wherein the driving assistance request comprises at least one of a driving destination, a state of the user, information related to the autonomous driving of the vehicle, a location of the vehicle, or identification information of the vehicle.

4. The method of claim 3,
wherein the state of the user comprises at least one of whether the user is drunk, whether the user is elderly, whether the user is pregnant, or any other information related to health of the user,
wherein the information related to the autonomous driving of the vehicle comprises at least one of whether the vehicle is allowed to travel, whether an accident of the vehicle happens, information on a sensor in which the error is detected among sensors of the vehicle, or whether the vehicle supports an autonomous driving function, and
wherein the identification information of the vehicle comprises at least one of a color, a type, or a licensed number of the vehicle.

5. The method of claim 1, wherein the transmitting of the driving assistance request further comprises:
receiving information on the drone selected by the server; and
receiving an authentication key that is generated by the server to connect the drone and the vehicle.

6. The method of claim 5, wherein the authentication key is valid only before a preset valid time expires since a generation timing of the authentication key.

7. The method of claim 6, wherein, when a valid time of the authentication key expires, the vehicle requests update of the authentication key from the server and receives a re-generated authentication key from the server

8. The method of claim 1, wherein the receiving of the connection request comprises:
receiving real-time information related to a location of the drone from the server; and
when a distance between the drone and the vehicle is equal to or smaller than a predetermined value, receiving the connection request from the drone.

9. The method of claim 8, wherein the real-time information comprises at least one of a current location of the drone, a moving path of the drone, or a time required for the drone to arrive at the vehicle.

10. The method of claim 1, wherein the initiating of the data transmission and reception comprises:
verifying validity of the connection request and transmitting connection approval to the drone; and
initiating the data transmission and reception with the drone, when the drone moves to a preset location in response to reception of the connection approval and is then electrically connected to the vehicle.

11. The method of claim 10, wherein the preset location is a landing point provided in an exterior of the vehicle or a location in a region formed at a preset distance from the vehicle.

12. The method of claim 10, wherein, when the data transmission and the reception is initiated, the vehicle transmits, to the drone, at least one of fuel of the vehicle, a remaining battery capacity of the vehicle, or real-time information of the vehicle related to the autonomous driving.

13. The method of claim 10, wherein, in the performing of the autonomous driving using the driving assistance data,
when the vehicle does not support an autonomous driving function, the vehicle performs the autonomous driving using at least one of sensor data acquired through a normally operating sensor or sensor data received from the drone, or
when the vehicle does not support the autonomous driving function, the vehicle operates in accordance with the autonomous driving control signal.

14. The method of claim 13, wherein the autonomous driving control signal indicates an operation of vehicular elements related to at least one of turning on/off ignition, a driving speed, gear shift, an engine RPM, turning on/off a head light, turning on/off a turn signal, or lane change.

15. A control method of an Automated Vehicle and Highway System (AVHS), the method comprising:
transmitting, by a vehicle, a driving assistance request to a server in response to satisfaction of a preset condition or in response to an input of a user;
transmitting, by the server, location information of the vehicle to a drone having a sensor for assisting autonomous driving of the vehicle;
approaching the vehicle and transmitting a connection request by the drone;
initiating, by the vehicle, data transmission and reception for autonomous driving by authenticating the connection request; and
performing, by the vehicle, the autonomous driving using driving assistance data received from the drone,
wherein the driving assistance data comprises at least one of first sensor data acquired through a sensor of the drone, second sensor data acquired through a sensor of a drone, the sensor corresponding to a sensor in which an error is detected among sensors of the vehicle, or an autonomous driving control signal indicating an operation of the vehicle.

16. The method of claim 15, wherein in the transmitting of the driving assistance request, the vehicle transmits the driving assistance request when an error is detected in at least one sensor, when an accident possibility is equal to or higher than a predetermined level, or when occurrence of an emergency is sensed.

17. The method of claim 16, wherein the driving assistance request comprises at least one of a driving destination, a state of the user, information related to the autonomous driving of the vehicle, a location of the vehicle, or identification information of the vehicle.

18. The method of claim 17,
wherein the state of the user comprises at least one of whether the user is drunk, whether the user is elderly, whether the user is pregnant, or any other information related to health of the user,
wherein the information related to the autonomous driving of the vehicle comprises at least one of whether the vehicle is allowed to travel, whether an accident of the vehicle happens, information on a sensor in which the error is detected among sensors of the vehicle, or whether the vehicle supports an autonomous driving function, and
wherein the identification information of the vehicle comprises at least one of a color, a type, or a licensed number of the vehicle.

19. The method of claim 15, wherein the transmitting of the location information of the vehicle comprises:
selecting, by the server, any one drone from among a plurality of drones registered in the server by a preset standard;
transmitting, by the server, information on the selected drone to the vehicle; and
transmitting, by the server, the location information of the vehicle to the selected drone.

20. The method of claim 19, wherein the selecting of any one drone by the preset standard comprises selecting, by the server, any one drone from among the plurality of drones by considering at least one of a degree of adjacency to the vehicle, whether a sensor necessary for the vehicle is provided, or a remaining battery capacity required to assist the autonomous driving of the vehicle.
